(19) United States
(12) Patent Application Publication
(10) Pub. No.: US 2024/0006731 A1
(43) Pub. Date: Jan. 4, 2024

(54) ELECTRODE, METHOD OF MANUFACTURING ELECTRODE, AND BATTERY

(71) Applicant: MURATA MANUFACTURING CO., LTD., Kyoto (JP)

(72) Inventors: Toshikazu NAKAMURA, Kyoto (JP); Koji MORITA, Kyoto (JP); Makoto HAYAKAWA, Kyoto (JP); Akihito NAKAMURA, Kyoto (JP)

(21) Appl. No.: 18/368,768

(22) Filed: Sep. 15, 2023

Related U.S. Application Data
(63) Continuation of application No. PCT/JP2022/011236, filed on Mar. 14, 2022.

(30) Foreign Application Priority Data
Mar. 19, 2021 (JP) 2021-046579

(51) Int. Cl. H01M 50/595; H01M 50/486; H01M 10/04; H01M 50/466; H01M 50/406

(52) U.S. Cl. CPC H01M 50/595; H01M 50/486; H01M 10/0431; H01M 50/466; H01M 50/406

(57) ABSTRACT

An electrode includes an electrode body and a protective member. The protective member covers a surface of the electrode body. The electrode body includes a current collector and an active material layer. The current collector has a first end face. The active material layer is provided on at least a portion of a surface of the current collector. The protective member includes an unadhered part and an adhered part. The unadhered part is disposed on a side closer to the first end face and is unadhered to the electrode body. The adhered part is disposed on a side farther from the first end face, is coupled to the unadhered part, and is adhered to the electrode body.

### CROSS REFERENCE TO RELATED APPLICATIONS

The present application is a continuation of PCT patent application no. PCT/JP2022/011236, filed on Mar. 14, 2022, which claims priority to Japanese patent application no. 2021-046579, filed on Mar. 19, 2021, the entire contents of which are incorporated herein by reference.

### BACKGROUND

The present technology relates to an electrode, a method of manufacturing an electrode, and a battery.

A battery includes an electrode and an electrolytic solution. A configuration of the battery and a method of manufacturing the battery have been considered in various ways.

Specifically, while electrodes after being cut are fixed by means of chucks, respective tapes are applied to the cut electrodes to thereby couple the cut electrodes to each other via the tapes, following which the tapes are cut at a position in a gap between the cut electrodes. In this case, upon cutting the tapes, a separator is cut together with the electrodes.

A tape is applied to a portion or all of an outer edge of a positive electrode after being cut. In this case, the tape is folded back to cover from a front surface to a back surface via a side surface of the positive electrode.

A tape is applied on a positive electrode plate. In this case, the tape has a width greater than that of the positive electrode plate, and a portion of the tape over which an adhesive is applied has a width smaller than that of the positive electrode plate.

In a case where a current collector of an outermost positive electrode plate on which no electrode mixture layer is provided is longer than a current collector of an outermost negative electrode plate on which no electrode mixture layer is provided, a tape is applied to the current collector of the positive electrode plate.

In a positive electrode that includes a coated part in which a current collector is covered with an electrode mixture, and an uncoated part in which the current collector is not covered with the electrode mixture, a tape is bonded at a border between the coated part and the uncoated part.

A tape is applied to an end portion of an electrode after being cut. In this case, the tape is folded back to cover a front surface to a back surface via a side surface of the electrode. In addition, while the tape is applied to the electrode on a side closer to the end portion of the electrode, the tape is not applied to the electrode on a side farther from the end portion of the electrode.

### SUMMARY

The present technology relates to an electrode, a method of manufacturing an electrode, and a battery.

Although consideration has been given in various ways regarding a configuration of a battery and a method of manufacturing a battery, the battery still remains insufficient in each of a capacity characteristic, safety, and manufacturing stability. Accordingly, there is room for improvement in terms thereof.

It is therefore desirable to provide an electrode, a method of manufacturing an electrode, and a battery each of which makes it possible to achieve a superior capacity characteristic, superior safety, and superior manufacturing stability.

An electrode according to an embodiment includes an electrode body and a protective member. The protective member covers a surface of the electrode body. The electrode body includes a current collector and an active material layer. The current collector has a first end face. The active material layer is provided on at least a portion of a surface of the current collector. The protective member includes an unadhered part and an adhered part. The unadhered part is disposed on a side closer to the first end face and is unadhered to the electrode body. The adhered part is disposed on a side farther from the first end face, is coupled to the unadhered part, and is adhered to the electrode body.

A method of manufacturing an electrode according to an embodiment includes: preparing an electrode body and a protective member, the electrode body including a current collector and an active material layer provided on the current collector, the protective member including an unadhered part and paired adhered parts, the paired adhered parts being opposed to each other with the unadhered part interposed between the paired adhered parts; adhering the protective member to a surface of the electrode body via the paired adhered parts; and cutting the electrode body together with the protective member at the unadhered part.

A battery according to an embodiment includes a first electrode and an electrolytic solution. The first electrode has a configuration similar to that of the electrode according to an embodiment described herein.

According to the electrode of an embodiment, the electrode includes the electrode body and the protective member, the electrode body includes the current collector and the active material layer, the protective member includes the unadhered part and the adhered part, the unadhered part is disposed on the side closer to the first end face of the current collector and is unadhered to the electrode body, and the adhered part is disposed on the side farther from the first end face of the current collector and is adhered to the electrode body. This makes it possible to achieve a superior capacity characteristic, superior safety, and superior manufacturing stability.

According to the method of manufacturing an electrode according to an embodiment, the electrode body and the protective member are prepared, the electrode body including the current collector and the active material layer, the protective member including the unadhered part and the paired adhered parts; the protective member is adhered on the surface of the electrode body via the paired adhered parts; and thereafter, the electrode body is cut together with the protective member at the unadhered part. This makes it possible to obtain an electrode having a superior capacity characteristic, superior safety, and superior manufacturing stability.

According to the battery of an embodiment, the battery includes the first electrode having the configuration similar to that of the electrode described above. This makes it possible to achieve a superior capacity characteristic, superior safety, and superior manufacturing stability.

Note that effects of the present technology are not necessarily limited to those described herein and may include any of a series of suitable effects in relation to the present technology.

### BRIEF DESCRIPTION OF THE FIGURES

FIG. 1 is a sectional view of a configuration of an electrode according to an embodiment of the present technology.

FIG. 2 is a sectional diagram for describing a manufacturing process of the electrode according to an embodiment of the present technology.

FIG. 3 is a sectional diagram for describing a manufacturing process of the electrode, following FIG. 2.

FIG. 4 is a sectional diagram for describing a manufacturing process of the electrode, following FIG. 3.

FIG. 5 is a perspective view of a configuration of a protective member.

FIG. 6 is a sectional view of a configuration of an electrode according to Comparative example 1.

FIG. 7 is a sectional diagram for describing a manufacturing process of the electrode according to Comparative example 1.

FIG. 8 is a sectional view of a configuration of an electrode according to Comparative example 2.

FIG. 9 is a sectional diagram for describing a manufacturing process of the electrode according to Comparative example 2.

FIG. 10 is a sectional view of a configuration of an electrode according to Comparative example 3.

FIG. 11 is a sectional diagram for describing a manufacturing process of the electrode according to Comparative example 3.

FIG. 12 is a sectional view of a configuration of an electrode according to Comparative example 4.

FIG. 13 is a sectional diagram for describing a manufacturing process of the electrode according to Comparative example 4.

FIG. 14 is a sectional view of a configuration of an electrode according to an embodiment of the present technology.

FIG. 15 is a sectional diagram for describing a manufacturing process of the electrode according to an embodiment of the present technology.

FIG. 16 is a sectional diagram for describing a manufacturing process of the electrode, following FIG. 15.

FIG. 17 is a sectional diagram for describing a manufacturing process of the electrode, following FIG. 16.

FIG. 18 is a perspective view of a configuration of a secondary battery according to an embodiment of the present technology.

FIG. 19 is a sectional view of a configuration of a battery device illustrated in FIG. 18.

FIG. 20 is a sectional view of a configuration of an electrode according to an embodiment.

FIG. 21 is a sectional view of a configuration of an electrode according to an embodiment.

FIG. 22 is a sectional view of a configuration of each of an electrode and a secondary battery according to an embodiment.

FIG. 23 is a sectional view of a configuration of each of an electrode and a secondary battery according to an embodiment.

FIG. 24 is a sectional view of a configuration of an electrode according to an embodiment.

FIG. 25 is a sectional view of a configuration of each of an electrode and a secondary battery according to an embodiment.

FIG. 26 is a sectional view of a configuration of each of an electrode and a secondary battery according to an embodiment.

FIG. 27 is a sectional view of a configuration of an electrode according to an embodiment.

FIG. 28 is a perspective view of a configuration of a secondary battery according to an embodiment.

FIG. 29 is a sectional view of a configuration of a battery device illustrated in FIG. 28.

FIG. 30 is a sectional view of a configuration of a secondary battery according to an embodiment.

FIG. 31 is a sectional view of a configuration of a secondary battery according to an embodiment.

FIG. 32 is a sectional view of a configuration of a secondary battery according to an embodiment.

FIG. 33 is a block diagram illustrating a configuration of an application example of a battery.

### DETAILED DESCRIPTION

One or more embodiments of the present technology are described below in further detail including with reference to the drawings.

A description is given first of an electrode of an embodiment of the present technology.

The electrode to be described here is to be used in, for example, an electrochemical device. In this case, the electrode may be used as a positive electrode, may be used as a negative electrode, or may be used as each of the positive electrode and the negative electrode.

The electrochemical device is not particularly limited in kind, and specific examples thereof include a battery. Note that the battery may be a primary battery or a secondary battery.

FIG. 1 illustrates a sectional configuration of an electrode 10 that is the electrode. The electrode 10 includes an electrode body 1 and a protective member 2, as illustrated in FIG. 1. The protective member 2 covers a surface of the electrode body 1.

Hereinafter, an upper side in FIG. 1 is described as an upper side of the electrode 10, and a lower side in FIG. 1 is described as a lower side of the electrode 10. In addition, a right side in FIG. 1 is described as a right side of the electrode 10, and a left side in FIG. 1 is described as a left side of the electrode 10.

Here, the electrode 10 has a band-shaped structure extending in a lateral direction in FIG. 1. In this case, the protective member 2 is provided at each of one end part (a left end part) of the electrode body 1 and another end part (a right end part) of the electrode body 1. Further, the protective member 2 is provided on each of one (an upper surface) of two opposed surfaces of the electrode 10 and another (a lower surface) of the two opposed surfaces of the electrode 10.

The electrode 10 thus includes four protective members 2 separate from each other. That is, the electrode 10 includes the protective member 2 provided on the upper surface at the left end part, the protective member 2 provided on the lower surface at the left end part, the protective member 2 provided on the upper surface at the right end part, and the protective member 2 provided on the lower surface at the right end part.

The electrode body 1 is a main part of the electrode 10 used to cause an electrode reaction to proceed, for example, in an electrochemical device. The electrode body 1 includes a current collector 1A and an active material layer 1B. The active material layer 1B is provided on at least a portion of a surface of the current collector 1A.

The current collector 1A is an electrically conductive support that supports the active material layer 1i, and has two opposed surfaces (an upper surface and a lower surface) on each of which the active material layer 1B is to be provided. The current collector 1A includes one or more of electrically conductive materials including, without limitation, a metal material.

In addition, the current collector 1A has an exposed face 1AR serving as a first end face. Here, because the electrode 10 has the band-shaped structure extending in the lateral direction in FIG. 1 as described above, the current collector 1A also has a band-shaped structure. The current collector 1A thus has two exposed faces 1AR. A first one of the exposed faces 1AR is an end face located at one end (a left end) in a longitudinal direction (the lateral direction in FIG. 1) of the current collector 1A. A second one of the exposed faces 1AR is an end face located at another end (a right end) in the longitudinal direction of the current collector 1A.

Here, the active material layer 1B is provided on each of the two opposed surfaces of the current collector 1A. The electrode 10 thus includes two active material layers 1B. However, the active material layer 1B may be provided on only one of the two opposed surfaces of the current collector 1A, and the electrode 10 may thus include only one active material layer 1B. A method of forming the active material layer 1B is not particularly limited, and specifically includes one or more of methods including, without limitation, a coating method, a vapor-phase method, a liquid-phase method, a thermal spraying method, and a firing (sintering) method. Specific examples of the coating method include a doctor blade method, a die coating method, a gravure coating method, and a spray drying method.

The active material layer 1B includes one or more of active materials. Note that the active material layer 1B may further include one or more of other materials including, without limitation, a binder and a conductor.

The kind of the active material is not particularly limited, and specifically depends on the use of the electrode 10, that is, whether the electrode 10 is used as a positive electrode or is used as a negative electrode. Specific kinds of the active material corresponding to the use of the electrode 10 will be described later.

The binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The conductor includes one or more of electrically conductive materials including, without limitation, a carbon material. Examples of the carbon material include graphite, carbon black, acetylene black, and Ketjen black. Note that the electrically conductive material may be a metal material or a polymer compound, for example.

Here, as illustrated in FIG. 1, the active material layer 1B is provided on the current collector 1A from a position corresponding to the exposed face 1AR. That is, the active material layer 1B is provided on all of the surface of the current collector 1A. The active material layer 1B thus covers the entire current collector 1A, making the current collector 1A unexposed.

The active material layer 1B has an exposed face 1BR serving as a second end face on a side closer to the exposed face 1AR. Here, because the electrode 10 has the band-shaped structure extending in the lateral direction in FIG. 1 as described above, the active material layer 1B also has a band-shaped structure. The active material layer 1B thus has two exposed faces 1BR. A first one of the exposed faces 1BR is an end face located at one end (a left end) in a longitudinal direction of the active material layer 1B. A second one of the exposed end faces 1BR is an end face located at another end (a right end) in the longitudinal direction of the active material layer 1B.

Here, as described above, the active material layer 1B is provided on the current collector 1A from the position corresponding to the exposed face 1AR. Therefore, the entire exposed face 1BR is exposed.

The protective member 2 is provided on the electrode body 1 to protect the electrode body 1. The protective member 2 includes an unadhered part 2X and an adhered part 2Y coupled to the unadhered part 2X. The protective member 2 is thus adhered to the electrode body 1 via the adhered part 2Y.

Here, because the active material layer 1B is provided on the current collector 1A from the position corresponding to the exposed face 1AR as described above, the protective member 2 is disposed on the active material layer 1B. That is, the protective member 2 is adhered to the active material layer 1B via the adhered part 2Y.

The unadhered part 2X is a portion, of the protective member 2, unadhered to the electrode body 1. The unadhered part 2X covers the surface of the electrode body 1 from the position corresponding to the exposed face 1AR. More specifically, the unadhered part 2X covers the active material layer 1B from the position corresponding to the exposed face 1AR. That is, the unadhered part 2X is disposed on the side closer to the exposed face 1AR than the adhered part 2Y. The unadhered part 2X thus protects the active material layer 1B. Here, the unadhered part 2X is not present beyond the position corresponding to the exposed face 1AR, and therefore does not cover any portion of the exposed face 1BR.

In particular, although the unadhered part 2X is not adhered to the electrode body 1 (the active material layer 1i), the unadhered part 2X is preferably in contact with (closely attached to) the active material layer 1i, for example, by using electrostatic force. A reason for this is that it is easier for the unadhered part 2X to protect the active material layer 1B even if the unadhered part 2X is not adhered to the active material layer 1B.

The adhered part 2Y is a portion, of the protective member 2, adhered to the electrode body 1. The adhered part 2Y covers the surface of the electrode body 1 from a position at which the adhered part 2Y is coupled to the unadhered part 2X. More specifically, the adhered part 2Y covers the active material layer 1B from the position at which the adhered part 2Y is coupled to the unadhered part 2X. That is, the adhered part 2Y is disposed on a side farther from the exposed face 1AR than the unadhered part 2X. The adhered part 2Y thus protects the active material layer 1B.

A specific configuration of the protective member 2 is not particularly limited. Here, the protective member 2 is what is called a protective tape (an adhesive tape), and is thus adhered to the electrode body 1 by using an adhesive material. Specifically, as illustrated in FIG. 1, the protective member 2 includes a base layer 2A and an adhesive layer 2B provided on the base layer 2A.

The base layer 2A is a support member that supports the adhesive layer 2B. The base layer 2A includes one or more of polymer compounds. The one or more polymer compounds are not particularly limited in kind, and specifically include a non-fluorine-containing polymer compound, a fluorine-containing polymer compound, or both. A reason for this is that it is easier for the unadhered part 2X to be closely attached to the active material layer 1B by using the electrostatic force.

The non-fluorine-containing polymer compound includes one or more of polymer compounds that each do not include fluorine as a constituent element. Specific examples of the non-fluorine-containing polymer compound include polyethylene, polypropylene, polyimide, polyphenylene sulfide, polyvinyl chloride, and polyester.

The fluorine-containing polymer compound includes one or more of polymer compounds that each include fluorine as a constituent element. Specific examples of the fluorine-containing polymer compound include polyvinylidene difluoride, polytetrafluoroethylene, a perfluoroalkoxy alkane (a copolymer of tetrafluoroethylene and perfluoroalkoxy ethylene), and a perfluoroethylene propene copolymer (a copolymer of tetrafluoroethylene and hexafluoropropylene).

The adhesive layer 2B is provided on the base layer 2A in a range corresponding to the adhered part 2Y. The adhesive layer 2B includes one or more of adhesive materials including, without limitation, an acrylic-based adhesive, a urethane-based adhesive, and a rubber-based adhesive. Specific examples of the rubber-based adhesive include isobutyl rubber and silicone rubber.

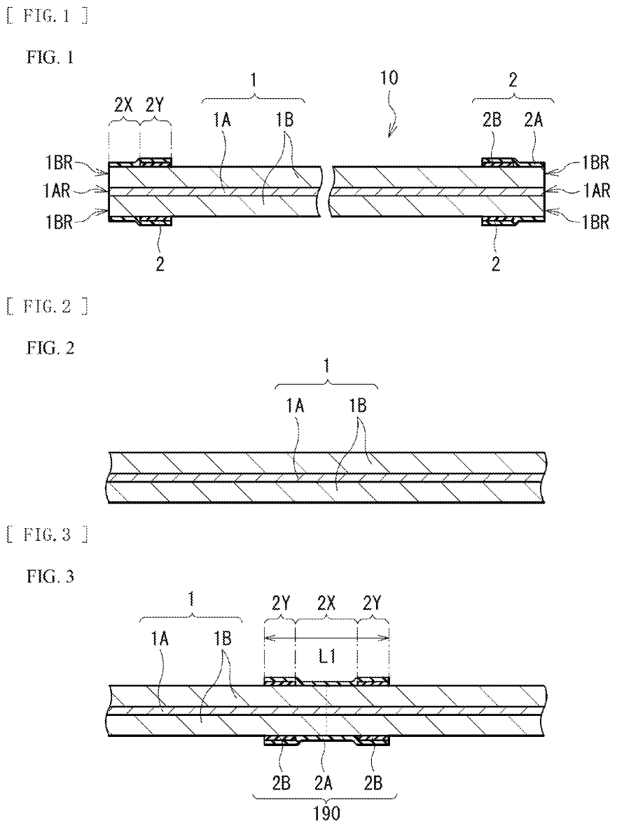

FIGS. 2 to 4 each illustrate a sectional configuration corresponding to FIG. 1 to describe manufacturing processes of the electrode 10. FIG. 5 illustrates a perspective configuration of a protective member 190. In the following, FIG. 1 already described will also be referred to where appropriate together with FIGS. 2 to 5. Note that in the description below, a dimension in a longitudinal direction of the electrode 10 in each of FIGS. 2 to 4 is referred to as a “length”.

In a case of manufacturing the electrode 10, first, the electrode body 1 and the protective member 190 are prepared. The protective member 190 is a precursor to be used to form the protective member 2.

Specifically, as illustrated in FIG. 5, the protective member 190 is continuously wound around a winding core 191, and includes the unadhered part 2X and the adhered part 2Y described above. The protective member 190 includes the base layer 2A and the adhesive layer 2B described above. Therefore, the unadhered part 2X and the adhered part 2Y include the base layer 2A and the adhesive layer 2B. In FIG. 5, the unadhered part 2X is lightly shaded, and the adhered part 2Y is darkly shaded.

More specifically, the protective member 190 includes the unadhered part 2X and the paired adhered parts 2Y. The paired adhered parts 2Y are opposed to each other with the unadhered part 2X interposed therebetween. Here, because the unadhered part 2X and the paired adhered parts 2Y each extend in a longitudinal direction of the protective member 190, the paired adhered parts 2Y are opposed to each other with the unadhered part 2X interposed therebetween in a lateral direction of the protective member 190.

Note that although not specifically illustrated here, the unadhered part 2X and the paired adhered parts 2Y may each extend in the lateral direction of the protective member 190, and the paired adhered parts 2Y may therefore be opposed to each other with the unadhered part 2X interposed therebetween in the longitudinal direction of the protective member 190.

In a case of forming the electrode body 1, first, a mixture (a mixture) in which materials including, without limitation, the active material, the binder, and the conductor are mixed with each other is put into a solvent to thereby prepare a mixture slurry in a paste form. The solvent may be an aqueous solvent, or may be an organic solvent. Thereafter, the mixture slurry is continuously applied on the two opposed surfaces of the current collector 1A having a band shape to thereby form the active material layers 1B. Lastly, the active material layers 1B are compression-molded by means of, for example, a roll pressing machine. In this case, the active material layers 1B may be heated. The active material layers 1B may be compression-molded multiple times. The active material layers 1B are thus formed on the two respective opposed surfaces of the current collector 1A, as illustrated in FIG. 2. As a result, the electrode body 1 having a band shape is formed.

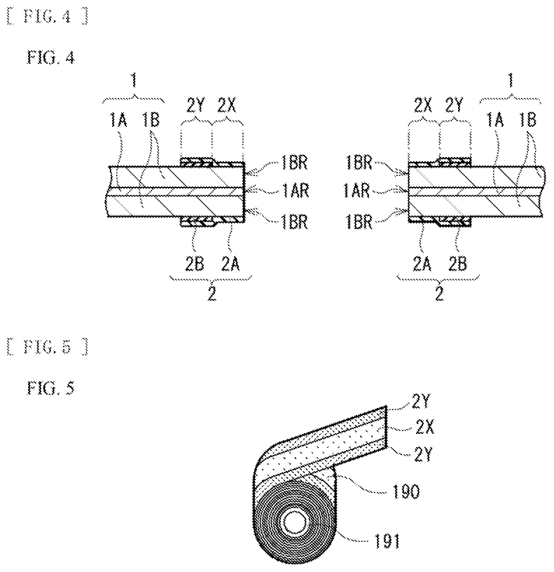

After the electrode body 1 and the protective member 190 are prepared, the protective member 190 is cut at a desired length (a length L1) to thereby adhere the protective member 190 to the surface of the electrode body 1 via the paired adhered parts 2Y as illustrated in FIG. 3. The length L1 may be set as desired. In this case, the protective member 190 is so disposed that the paired adhered parts 2Y are opposed to each other with the unadhered part 2X interposed therebetween in the longitudinal direction of the electrode body 1. In addition, the protective member 190 is adhered to each of an upper surface and a lower surface of the electrode body 1. Note that a dashed line in the electrode body 1 in FIG. 3 represents a location at which the electrode body 1 is to be cut in a later process.

Lastly, the electrode body 1 (the current collector 1A and the active material layers 1B) is cut together with the protective members 190 at the unadhered parts 2X by means of a cutting apparatus including a cutting blade. As result, the exposed face 1AR of the current collector 1A is formed and the respective exposed faces 1BR of the active material layers 1B are formed, as illustrated in FIG. 4. In this case, the electrode body 1 and the protective members 190 are each cut at multiple locations to have a desired length.

A cutting method used by the cutting apparatus is not particularly limited. In particular, one or more of a scissors method, a nip-type fixed blade cutting method (a guillotine cutting method), a rotary cutter method, a gang blade method, a shear blade method, and a score blade method are preferably used. A reason for this is that the adhesive material of the protective members 190 (the adhesive layers 2B) is prevented from easily sticking to the cutting blade, which makes it easier to smoothly and stably cut each of the electrode body 1 and the protective members 190 by means of the cutting apparatus.

This cutting process allows the electrode body 1 to be separated at a cutting location and the protective members 190 are each separated at the unadhered part 2X, forming each of the protective members 2 each including the unadhered part 2X and the adhered parts 2Y on corresponding one of the two opposed surfaces of the electrode body 1. More specifically, the current collector 1A, the active material layers 1i, and the protective members 190 are each separated at multiple locations. The protective members 2 are thus formed on the surface of each of the active material layers 1B.

Accordingly, as illustrated in FIG. 1, the protective member 2 is provided on each of the upper surface at the left end part, the upper surface at the right end part, the lower surface at the left end part, and the lower surface at the right end part of the electrode body 1. As a result, the electrode 10 including the electrode body 1 and the four protective members 2 is completed.

The electrode 10 makes it possible to achieve the following action and effects according to an embodiment.

First, according to the electrode 10, the electrode 10 includes the electrode body 1 and the protective members 2. The electrode body 1 includes the current collector 1A and the active material layers 1B. The protective members 2 each include the unadhered part 2X and the adhered part 2Y. The unadhered part 2X is disposed on the side closer to the exposed face 1AR and is unadhered to the electrode body 1. In contrast, the adhered part 2Y is disposed on the side farther from the exposed face 1AR and is adhered to the electrode body 1. This makes it possible to achieve a superior capacity characteristic, superior safety, and superior manufacturing stability for the following reasons.

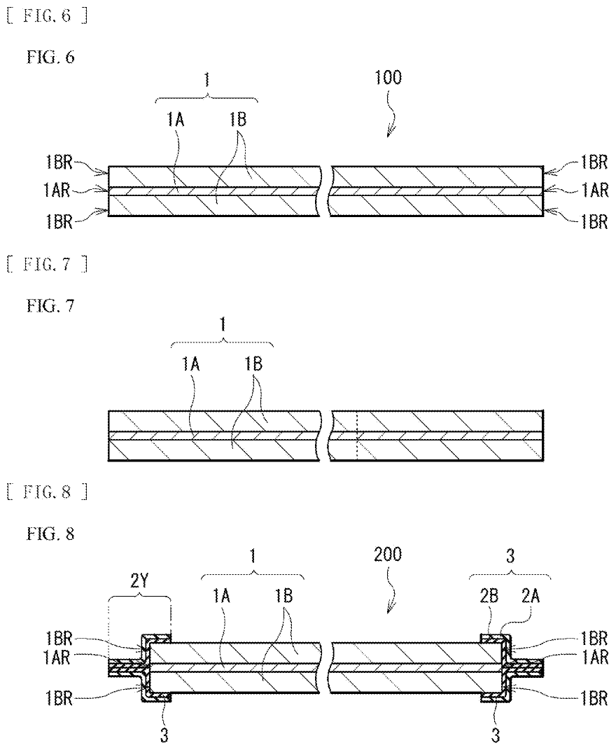

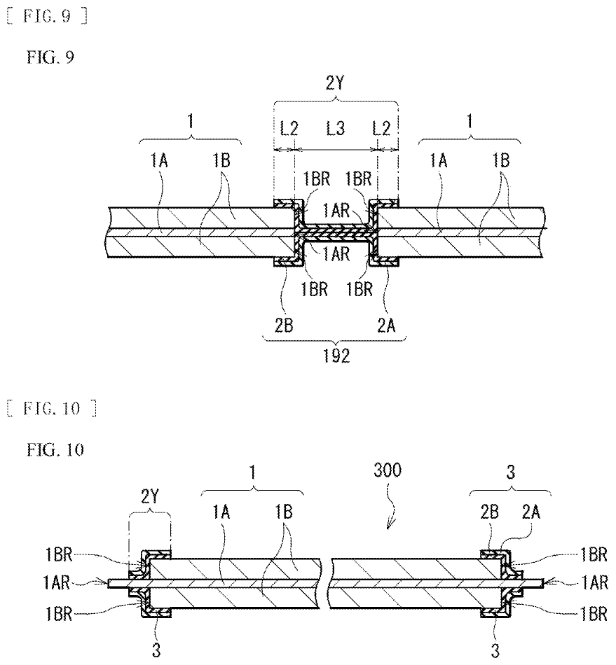

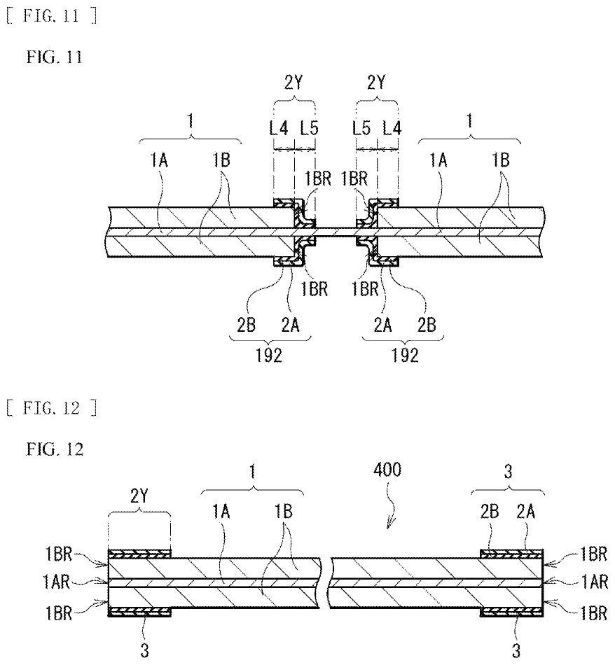

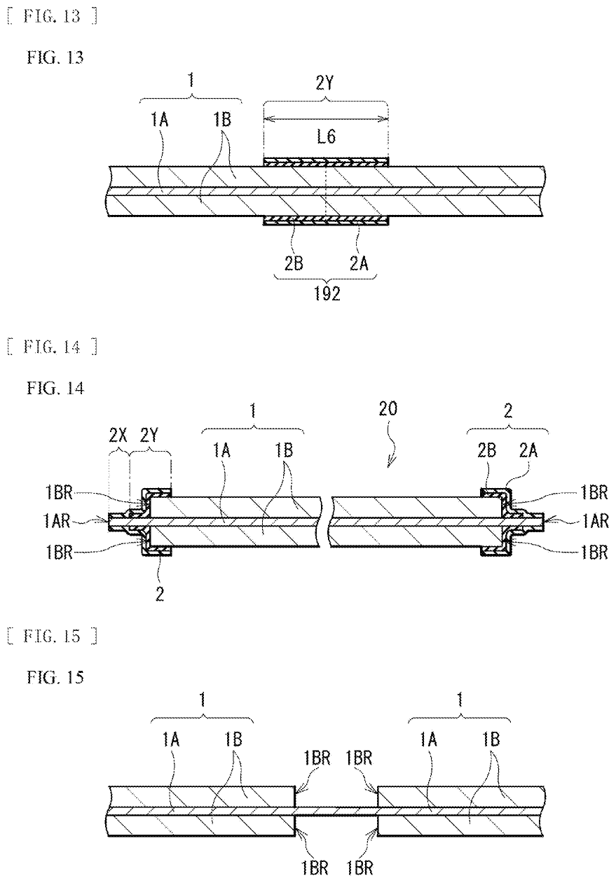

FIG. 6 illustrates a sectional configuration of an electrode 100 of Comparative example 1. FIG. 7 illustrates a manufacturing process of the electrode 100. FIG. 8 illustrates a sectional configuration of an electrode 200 of Comparative example 2. FIG. 9 illustrates a manufacturing process of the electrode 200. FIG. 10 illustrates a sectional configuration of an electrode 300 of Comparative example 3. FIG. 11 illustrates a manufacturing process of the electrode 300. FIG. 12 illustrates a sectional configuration of an electrode 400 of Comparative example 4. FIG. 13 illustrates a manufacturing process of the electrode 400. Note that FIGS. 6, 8, 10, and 12 each illustrate a sectional configuration corresponding to FIG. 1, and FIGS. 7, 9, 11, and 13 each illustrate a sectional configuration corresponding to any of FIGS. 2 to 4.

As illustrated in FIG. 6, the electrode 100 of Comparative example 1 has a configuration similar to that of the electrode 10 of the embodiment except for not including the protective member 2. As illustrated in FIG. 7, the electrode 100 is manufactured by a procedure similar to the manufacturing procedure of the electrode 10 except that the electrode body 1 is formed and thereafter the electrode body 1 is cut.

As illustrated in FIG. 8, the electrode 200 of Comparative example 2 has a configuration similar to that of the electrode 10 of the embodiment except that a protective member 3 is included in place of each of the protective members 2 and that the exposed faces 1AR and 1BR are each covered with the protective member 3.

Specifically, the protective members 3 each have a configuration similar to that of the protective member 2 except that the adhesive layer 2B is provided on the entire base layer 2A and the entire protective member 3 therefore serves as the adhered part 2Y.

In addition, the protective members 3 are present beyond the electrode body 1 at one end part of the electrode body 1 in the longitudinal direction. Therefore, the protective members 3 are adhered to each other at the one end part. Similarly, the protective members 3 are present beyond the electrode body 1 at another end part of the electrode body 1 in the longitudinal direction. Therefore, the protective members 3 are adhered to each other at the other end part. Accordingly, the exposed faces 1AR and 1BR are each covered with the protective member 3 at the one end part of the electrode body 1, and the exposed faces 1AR and 1BR are each covered with the protective member 3 at the other end part of the electrode body 1.

The electrode 200 is manufactured by a procedure similar to the manufacturing procedure of the electrode 10 except that the electrode body 1 is formed and the formed electrode body 1 is cut, following which, as illustrated in FIG. 9, protective members 192 are each adhered to each of the two pieces of the electrode body 1 separated from each other in such a manner that the protective members 192 each extend from one of the two pieces of the electrode body 1 to another via a region in the middle thereof. The protective members 192 are each used to form the protective member 3. In this case, one end part of each of the protective members 192 is adhered to one of the two pieces of the electrode body 1, and another end part of each of the protective members 192 is adhered to another of the two pieces of the electrode body 1. In addition, the protective members 192 are adhered to each other in the region between the two pieces of the electrode body 1. Thus, the exposed faces 1AR and 1BR are each covered with the protective members 192 in one of the two pieces of the electrode body 1, and the exposed faces 1AR and 1BR are each covered with the protective members 192 in the other of the two pieces of the electrode body 1.

Here, as illustrated in FIG. 9, a dimension of a portion of the protective member 192 adhered to the electrode body 1 is set to a length L2, and a dimension of the remaining portion of the protective member 192 (a portion located between the two pieces of the electrode body 1) is set to a length L3. The lengths L2 and L3 may each be set as desired.

As illustrated in FIG. 10, the electrode 300 of Comparative example 3 has a configuration similar to that of the electrode 10 of the embodiment except that the protective member 3 is included in place of each of the protective members 2 and that each leading end part of the current collector 1A is not covered with the protective member 3 and is exposed.

Specifically, at one end part of the electrode body 1 in the longitudinal direction, the active material layers 1B are each provided on the current collector 1A from a position recessed relative to the position corresponding to the exposed face 1AR. That is, the active material layers 1B are each recessed relative to the position corresponding to the exposed face 1AR toward an inner side. The current collector 1A is therefore exposed at the one end part. Similarly, at another end part of the electrode body 1 in the longitudinal direction, the active material layers 1B are each recessed relative to the position corresponding to the exposed face 1AR toward the inner side. The current collector 1A is therefore exposed at the other end part. The protective members 3 each cover from the active material layer 1B to a portion of the exposed portion of the current collector 1A. Each of the leading end parts of the current collector 1A is therefore not covered with the protective member 3 and is exposed, as described above. Accordingly, the exposed faces 1BR are each covered with the protective member 3 at the one end part of the electrode body 1, and the exposed faces 1BR are each covered with the protective member 3 at the other end part of the electrode body 1.

As will be described later, the electrode 300 is manufactured by a procedure similar to the manufacturing procedure of the electrode 10 except that: the mixture slurry is applied intermittently on the two opposed surfaces of the current collector 1A to form the active material layers 1B separate from each other in the longitudinal direction; and the protective members 192 are each adhered to corresponding one of the pieces of the electrode body 1 to cover from the active material layer 1B to a portion of the exposed portion of the current collector 1A as illustrated in FIG. 11. In this case, one end part of each of the protective members 192 is adhered to one of two pieces of the electrode body 1, and another end part of each of the protective members 192 is adhered to a portion of the exposed portion of the current collector 1A. In addition, two of the protective members 192 adjacent to each other are separate from each other. Accordingly, the exposed faces 1BR are each covered with the protective member 192 in one of the two pieces of the electrode body 1, and the exposed faces 1BR are each covered with the protective member 192 in the other of the two pieces of the electrode body 1.

Here, as illustrated in FIG. 11, a dimension of a portion, of the protective member 192, adhered to the active material layer 1B is set to a length L4, and a dimension of a portion, of the protective member 192, adhered to the current collector 1A is set to a length L5. The lengths L4 and L5 may each be set as desired.

As illustrated in FIG. 12, the electrode 400 of Comparative example 4 has a configuration similar to that of the electrode 10 of the embodiment except that the protective member 3 is included in place of each of the protective members 2. As illustrated in FIG. 13, the electrode 400 is manufactured by a procedure similar to the manufacturing procedure of the electrode 10 except that the electrode body 1 is formed and the protective members 192 (each having a length L6) are adhered to the electrode body 1, following which the protective members 192 are cut together with the electrode body 1.

As illustrated in FIG. 6, the electrode 100 of Comparative example 1 does not have any surplus portion at either end part of the electrode body 1 in the longitudinal direction. The surplus portion is a portion where no active material layer 1B is provided and the current collector 1A is exposed, that is, a portion not involved in the electrode reaction. This increases a volume energy density of the electrode 100, and therefore increases a capacity of an electrochemical device including the electrode 100.

In addition, as illustrated in FIG. 7, because no protective member 2 is provided on the electrode body 1, only the electrode body 1 is cut while no protective member 190 is cut in the manufacturing process of the electrode 100. In this case, the adhesive material of the protective member 190 (the adhesive layer 2B) does not stick to the cutting blade. This prevents an occurrence of a failure in cutting due to the sticking of the adhesive material to the cutting blade. Accordingly, a life of the cutting blade increases, and upon winding the electrode 100, an unintended defective winding due to the sticking of the adhesive material is prevented from easily occurring. This facilitates stable manufacturing of the electrode 100.

However, as illustrated in FIG. 6, because no protective member 2 is provided on the electrode body 1, each of corner parts of the active material layers 1B present at the position corresponding to the exposed face 1AR is not protected by the protective member 2 and is exposed. In this case, as will be described later, if the electrode 100 is included in an electrochemical device in a state of being stacked with a separator interposed, each of the corner parts of the active material layers 1B easily breaks through the separator. This easily leads to occurrence of a short circuit due to the unintended exposure of the electrode 100 (the current collector 1A). That is, in a case where two kinds of electrodes, i.e., the positive electrode and the negative electrode, are separated away from each other with the separator interposed therebetween, one of the positive electrode or the negative electrode easily comes into contact with another. This easily leads to occurrence of a short circuit in the electrochemical device. A reason for this is that, for example, in a case where a wound body is pressed in a manufacturing process of a secondary battery (a process of pressing the wound body) to be described later, a corner part of one of the positive electrode or the negative electrode easily comes into contact with another of the positive electrode or the negative electrode.

Based on the above, the electrode 100 of Comparative example 1 achieves a high volume energy density and allows for stable manufacturing of the electrode 100, but on the other hand, easily causes occurrence of a short circuit. It is therefore difficult to achieve a superior capacity characteristic, superior safety, and superior manufacturing stability.

As illustrated in FIG. 8, in the electrode 200 of Comparative example 2, because the protective members 3 are provided on the electrode body 1, each of the corner parts of the active material layers 1B is not exposed and is covered with the protective member 3. Accordingly, even if the electrode 200 is included in an electrochemical device in a state of being stacked with a separator interposed, each of the corner parts of the active material layers 1B is prevented from easily breaking through the separator. This prevents a short circuit from easily occurring.

However, as illustrated in FIG. 8, a surplus portion (a portion of each of the protective members 3) is present at each end part of the electrode body 1 in the longitudinal direction. This decreases a volume energy density of the electrode 200, and therefore reduces a capacity of an electrochemical device including the electrode 200.

In addition, as illustrated in FIG. 9, because the protective members 192 are adhered to the electrode body 1, the protective members 192 (the adhesive layers 2B each serving as the adhered part 2Y) is cut together with the electrode body 1 in the manufacturing process of the electrode 200. In this case, the adhesive material sticks to the cutting blade, which easily leads to occurrence of a failure in cutting. Accordingly, a life of the cutting blade is reduced, and upon winding the electrode 200, defective winding easily occurs. This hinders stable manufacturing of the electrode 200.

Based on the above, the electrode 200 of Comparative example 2 prevents a short circuit from easily occurring, but on the other hand, decreases the volume energy density and hinders stable manufacturing of the electrode 200. It is therefore difficult to achieve a superior capacity characteristic, superior safety, and superior manufacturing stability.

As illustrated in FIG. 10, in the electrode 300 of Comparative example 3, because the protective members 3 are provided on the electrode body 1, each of the corner parts of the active material layers 1B is not exposed and is covered with the protective member 3. Accordingly, even if the electrode 300 is included in an electrochemical device in a state of being stacked with a separator interposed, a short circuit is prevented from easily occurring.

In addition, as illustrated in FIG. 11, although the protective members 192 are adhered to the electrode body 1, the protective members 192 are not cut and the current collector 1A is cut in the manufacturing process of the electrode 300. In this case, the adhesive material does not stick to the cutting blade, which does not lead to occurrence of a failure in cutting. Accordingly, a life of the cutting blade increases, and even upon winding the electrode 300, defective winding is prevented from easily occurring. This facilitates stable manufacturing of the electrode 300.

However, as illustrated in FIG. 10, a surplus portion (a portion of each of the current collector 1A and the protective members 3) is present at each end part of the electrode body 1 in the longitudinal direction. In this case, allowing a portion of the current collector 1A to be covered with the protective members 3 and allowing the remaining portion of the current collector 1A to be exposed increases the length of the surplus portion. This decreases a volume energy density of the electrode 300, and therefore reduces a capacity of an electrochemical device including the electrode 300.

Based on the above, the electrode 300 of Comparative example 3 prevents a short circuit from easily occurring and allows for stable manufacturing of the electrode 300, but on the other hand, decreases the volume energy density. It is therefore difficult to achieve a superior capacity characteristic, superior safety, and superior manufacturing stability.

As illustrated in FIG. 12, in the electrode 400 of Comparative example 4, because the protective members 3 are provided on the electrode body 1, each of the corner parts of the active material layers 1B is not exposed and is covered with the protective member 3. Accordingly, even if the electrode 400 is included in an electrochemical device in a state of being stacked with a separator interposed, a short circuit is prevented from easily occurring.

In addition, as illustrated in FIG. 12, no surplus portion is present at either end part of the electrode body 1 in the longitudinal direction. This increases a volume energy density of the electrode 400, and therefore increases a capacity of an electrochemical device including the electrode 400.

However, as illustrated in FIG. 13, because the protective members 192 are adhered to the electrode body 1, the protective members 192 (the adhesive layers 2B serving as the adhered parts 2Y) are cut together with the electrode body 1 in the manufacturing process of the electrode 400. In this case, the adhesive material sticks to the cutting blade, which easily leads to occurrence of a failure in cutting. Accordingly, a life of the cutting blade is reduced, and upon winding the electrode 400, defective winding easily occurs. This hinders stable manufacturing of the electrode 400.

Based on the above, the electrode 400 of Comparative example 4 prevents a short circuit from easily occurring and achieves a high volume energy density, but on the other hand, hinders stable manufacturing of the electrode 400. It is therefore difficult to achieve a superior capacity characteristic, superior safety, and superior manufacturing stability.

In contrast, as illustrated in FIG. 1, the electrode 10 of the embodiment includes no surplus portion at either end part of the electrode body 1 in the longitudinal direction. This increases a volume energy density of the electrode 10, and therefore increases a capacity of an electrochemical device including the electrode 10.

In addition, as illustrated in FIGS. 2 to 4, although the protective members 190 are adhered to the electrode body 1, the adhered parts 2Y (the adhesive layers 2B) are not cut together with the electrode body 1 and the unadhered parts 2X (the base layers 2A) are cut in the manufacturing process of the electrode 10. In this case, the adhesive material does not stick to the cutting blade, which does not lead to occurrence of a failure in cutting. Accordingly, a life of the cutting blade increases, and upon winding the electrode 10, defective winding is prevented from easily occurring. This facilitates stable manufacturing of the electrode 10.

In addition, as illustrated in FIG. 1, because the protective members 2 are provided on the electrode body 1, each of the corner parts of the active material layers 1B is not exposed and is covered with the protective member 2. In this case, even if the electrode 10 is included in an electrochemical device in a state of being stacked with a separator interposed, a short circuit is prevented from easily occurring.

Based on the above, in the electrode 10 of the embodiment, the use of the protective members 2 (each including the unadhered part 2X and the adhered part 2Y) provided on the electrode body 1 makes it possible to achieve a high volume energy density and facilitate stable manufacturing of the electrode 10, and also makes it possible to prevent a short circuit from easily occurring. It is therefore possible to achieve a superior capacity characteristic, superior safety, and superior manufacturing stability.

In the electrode 10, in particular, the unadhered parts 2X may each be in contact with the electrode body 1 (the active material layer 1). This allows each of the active material layers 1B to be protected easily even if the unadhered part 2X is not adhered to the active material layer 1B. Accordingly, it is possible to achieve higher effects.

In addition, the active material layers 1B may each be provided on all of the surface of the current collector 1A, and the protective members 2 may each be disposed on the active material layer 1B. This allows each of the corner parts of the active material layers 1B to be sufficiently protected by the protective member 2. Accordingly, it is possible to achieve higher effects.

In addition, the protective members 2 may each include the base layer 2A and the adhesive layer 2B. This easily and stably provides the protective members 2 each including the unadhered part 2X and the adhered parts 2Y by using the base layer 2A and the adhesive layer 2B. Accordingly, it is possible to achieve higher effects. In this case, the base layer 2A may include the non-fluorine-containing polymer compound, the fluorine-containing polymer compound, or both. The non-fluorine-containing polymer compound may include, without limitation, polyethylene. The fluorine-containing polymer compound may include, without limitation, polytetrafluoroethylene. This allows the unadhered part 2X to be closely attached to the active material layer 1B easily by using electrostatic force. Accordingly, it is possible to achieve further higher effects.

In addition to the above, according to the method of manufacturing the electrode 10, the electrode body 1 (including the current collector 1A and the active material layers 1B) and the protective members 190 (each including the unadhered part 2X and the paired adhered parts 2Y) are used, and the protective members 190 are each attached to the surface of the electrode body 1 (the active material layer 1B) via the paired adhered parts 2Y, following which the electrode body 1 (the current collector 1A and the active material layers 1B) is cut together with the protective members 190 at the unadhered parts 2X.

In this case, as described above, cutting each of the protective members 190 at the unadhered part 2X allows the protective members 2 each including the unadhered part 2X and the adhered parts 2Y to be formed on the surface of the electrode body 1. This achieves a high volume energy density, suppresses occurrence of a short circuit, and in addition, facilitates stable manufacturing of the electrode 10, as described above. It is therefore possible to obtain the electrode 10 having a superior capacity characteristic, superior safety, and superior manufacturing stability.

In particular, the cutting method including, without limitation, a scissors method may be used to cut each of the electrode body 1 and the protective members 190. This allows each of the electrode body 1 and the protective members 190 to be cut easily and stably, allowing the protective members 2 each including the unadhered part 2X and the adhered parts 2Y to be formed on the surface of the electrode body 1 easily and stably. Accordingly, it is possible to achieve higher effects.

A description is given next of an electrode of another embodiment of the present technology.

The electrode has a configuration similar to that of the electrode described above except that the electrode body 1 has a different configuration, and that the protective member 2 provided on the electrode body 1 has a different configuration, accordingly.

The configuration of the electrode is similar to that of the electrode described above except for the points described below. In addition, a manufacturing method of an electrode is similar to that of the electrode described above except for the points described below.

FIG. 14 illustrates a sectional configuration of an electrode 20, and corresponds to FIG. 1. The electrode 20 includes the electrode body 1 and the four protective members 2 separated from each other, as illustrated in FIG. 14.

Here, the two active material layers 1B are each provided on the current collector 1A from a position recessed relative to the position corresponding to the exposed face 1AR toward the inner side. That is, the two active material layers 1B are each provided on the current collector 1A from a position shifted toward the inner side of the electrode body 1 relative to the position corresponding to the exposed face 1AR. That is, the active material layers 1B are each provided on a portion of the surface of the current collector 1A. The exposed faces 1BR are thus each recessed relative to the exposed face 1AR toward an inner side of the active material layer 1B.

Here, because the active material layers 1B are each provided on the current collector 1A from the position recessed relative to the position corresponding to the exposed face 1AR as described above, the protective members 2 (each including the unadhered part 2X and the adhered part 2Y) are each disposed on both the current collector 1A and the active material layer 1B. Thus, the protective members 2 are each adhered to the electrode body 1 via the adhered part 2Y, and more specifically, are each adhered to each of the current collector 1A and the active material layer 1B via the adhered part 2Y.

FIGS. 15 to 17 each illustrate a sectional configuration corresponding to FIG. 14 to describe a manufacturing process of the electrode 20. In the following, FIGS. 5 and 14 already described will also be referred to where appropriate together with FIGS. 15 to 17.

In a case of forming the electrode body 1, the mixture slurry is intermittently applied on the two opposed surfaces of the current collector 1A having a band shape to thereby form the active material layers 1B each having the exposed face 1BR, as illustrated in FIG. 15. Thus, the current collector 1A is exposed at multiple locations where no active material layer 1B is formed.

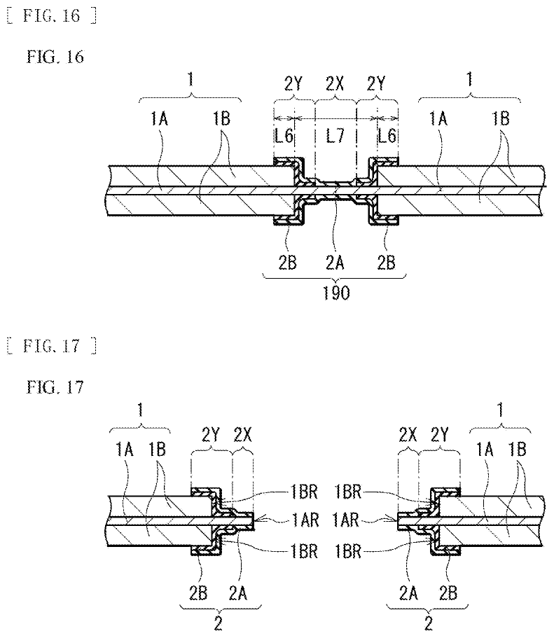

In a case of adhering the protective members 190 (each including the unadhered part 2X and the paired adhered parts 2Y) to the electrode body 1, as illustrated in FIG. 16, the protective members 190 are each adhered to the surface of the electrode body 1 via the paired adhered parts 2Y. In this case, the protective members 190 are each adhered to each of the current collector 1A and the active material layer 1B on one side via one of the adhered parts 2Y, and the protective members 190 are each adhered to each of the current collector 1A and the active material layer 1B on another side via another of the adhered parts 2Y. Note that a dashed line in the electrode body 1 in FIG. 16 represents a location at which the electrode body 1 is to be cut in a later process.

Here, as illustrated in FIG. 16, a dimension of a portion, of the protective member 2, adhered to the active material layer 1B is set to a length L6, and a dimension of the remaining portion of the protective member 2 (a portion between the active material layers 1B on the two sides) is set to a length L7. The lengths L6 and L7 may each be set as desired.

In a case of cutting each of the electrode body 1 and the protective members 190, the electrode body 1 (the current collector 1A) is cut together with the protective members 190 at the unadhered parts 2X. As a result, the exposed face 1AR of the current collector 1A on the one side is formed, and the exposed face 1AR of the current collector 1A on the other side is formed, as illustrated in FIG. 17. In this case, each of the current collector 1A and the protective members 190 is cut at multiple locations to have a desired length.

This cutting process allows the electrode body 1 to be separated at a cutting location and the protective members 190 are each separated at the unadhered parts 2X, forming each of the protective members 2 each including the unadhered part 2X and the adhered part 2Y on the surface of the electrode body 1. More specifically, the current collector 1A and the protective members 190 are separated at multiple locations. The protective member 2 is thus formed on the surface of each of the current collector 1A and the active material layers 1B.

Thus, as illustrated in FIG. 14, the electrode 20 including the electrode body 1 and the four protective members 2 is completed.

The electrode 20 includes the electrode body 1 (including the current collector 1A and the active material layers 1B) and the protective members 2 (each including the unadhered part 2X and the adhered part 2Y). The unadhered part 2X is unadhered to the electrode body 1 (the current collector 1A and the active material layer 1B) on the side closer to the exposed face 1AR. In contrast, the adhered part 2Y is adhered to the electrode body 1 (the current collector 1A and the active material layer 1B) on the side farther from the exposed face 1AR.

In this case also, based on reasons similar to those in the case described in relation to the electrode 10, the use of the protective members 2 (each including the unadhered part 2X and the adhered part 2Y) provided on the electrode body 1 makes it possible to achieve a high volume energy density and facilitate stable manufacturing of the electrode 20, and also makes it possible to prevent a short circuit from easily occurring.

In this case, if the length of the exposed portion of the current collector 1A, more specifically, the length of the unadhered part 2X is set to be sufficiently small, the length of the surplus portion becomes sufficiently small, which makes it possible to achieve a high volume energy density. In addition, if the length of the unadhered part 2X is set to be sufficiently small within the range in which the unadhered part 2X is cuttable together with the electrode body 1, it is possible to cut the protective member 2 at the unadhered part 2X while securing the volume energy density.

Accordingly, as with the electrode 10, it is possible to achieve a superior capacity characteristic, superior safety, and superior manufacturing stability.

In this case, in particular, unlike the electrode 10, not only the upper surfaces and the lower surfaces of the active material layers 1B but also the side surfaces (the exposed faces 1BR) are protected by the protective members 2. This further suppresses occurrence of a short circuit, making it possible to further improve safety.

In particular, the unadhered parts 2X may each be in contact with the electrode body 1 (the current collector 1A). This allows each of the active material layers 1B to be protected easily even if the unadhered part 2X is not adhered to the active material layer 1B. Accordingly, it is possible to achieve higher effects.

In addition to the above, according to the method of manufacturing the electrode 20, the electrode body 1 (including the current collector 1A and the active material layers 1B) and the protective members 190 (each including the unadhered part 2X and the paired adhered parts 2Y) are used, and the protective members 190 are each attached to the surface of the electrode body 1 (the current collector 1A and the active material layer 1B) via the paired adhered parts 2Y, following which the electrode body (the current collector 1A) is cut together with the protective members 190 at the unadhered parts 2X.

Accordingly, based on reasons similar to those in the case described in relation to the method of manufacturing the electrode 10, it is possible to achieve a high volume energy density, suppress occurrence of a short circuit, and in addition, facilitate stable manufacturing of the electrode 20. It is therefore possible to obtain the electrode 20 having a superior capacity characteristic, superior safety, and superior manufacturing stability.

Other actions and effects of the electrode 20 are similar to the other actions and effects of the electrode 10. In addition, other actions and effects of the method of manufacturing the electrode 20 are similar to the other actions and effects of the method of manufacturing the electrode 10.

A description is given next of a battery including an electrode according to an embodiment.

The battery to be described here is a secondary battery that obtains a battery capacity using insertion and extraction of an electrode reactant, and includes a positive electrode, a negative electrode, and an electrolytic solution. The electrolytic solution is a liquid electrolyte.

In the secondary battery, a charge capacity of the negative electrode is greater than a discharge capacity of the positive electrode. In other words, an electrochemical capacity per unit area of the negative electrode is set to be greater than an electrochemical capacity per unit area of the positive electrode. This is to prevent precipitation of the electrode reactant on a surface of the negative electrode during charging.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is what is called a lithium-ion secondary battery. In the lithium-ion secondary battery, lithium is inserted and extracted in an ionic state.

Note that as described above, the electrode may be used as the positive electrode, may be used as the negative electrode, or may be used as each of the positive electrode and the negative electrode. The following description refers to an example case where the electrode is used as the positive electrode. Note that the electrode 10 may be applied to the positive electrode, or the electrode 20 may be applied to the positive electrode.

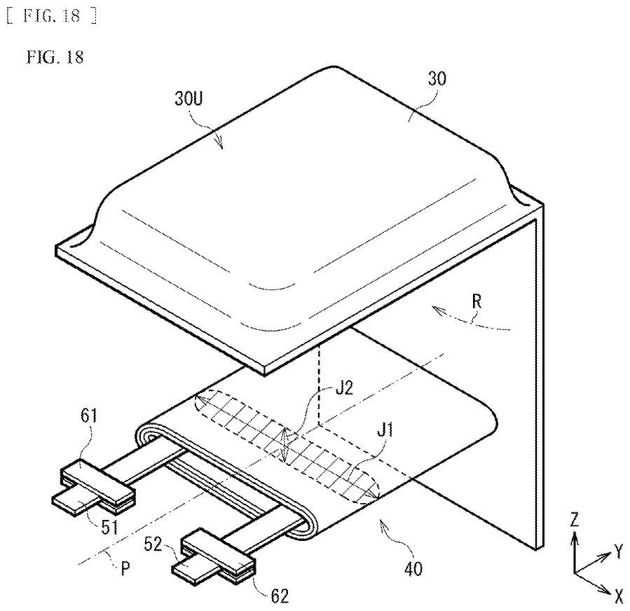

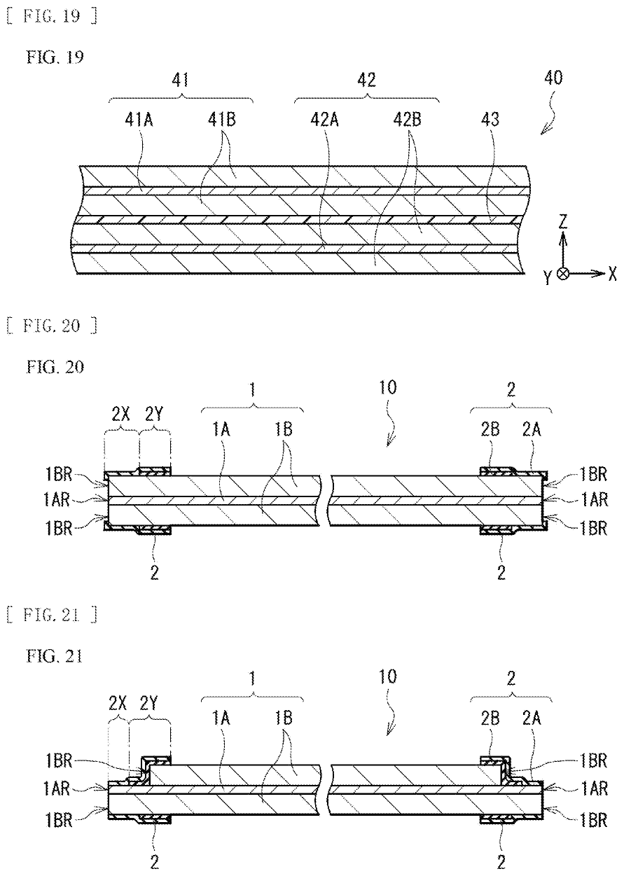

FIG. 18 illustrates a perspective configuration of the secondary battery. FIG. 19 illustrates a sectional configuration of a battery device 40 illustrated in FIG. 18. Note that FIG. 19 illustrates only a portion of the battery device 40.

As illustrated in FIGS. 18 and 19, the secondary battery includes an outer package film 30, the battery device 40, a positive electrode lead 51, a negative electrode lead 52, and sealing films 61 and 62. The secondary battery described here is a secondary battery of a laminated-film type in which the outer package film 30 having flexibility or softness is used.

As illustrated in FIG. 18, the outer package film 30 is a flexible outer package member that contains the battery device 40. The outer package film 30 has a pouch-shaped structure in which the battery device 40 is sealed in a state of being contained inside the outer package film 30. The outer package film 30 thus contains a positive electrode 41, a negative electrode 42, and an electrolytic solution that are to be described later.

Here, the outer package film 30 is a single film-shaped member, and is folded toward a folding direction R. The outer package film 30 has a depression part 30U to place the battery device 40 therein. The depression part 30U is what is called a deep drawn part.

Specifically, the outer package film 30 is a three-layered laminated film including a fusion-bonding layer, a metal layer, and a surface protective layer that are stacked in this order from an inner side. In a state in which the outer package film 30 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 30 is not particularly limited in configuration or the number of layers, and may be single-layered or two-layered, or may include four or more layers.

The sealing film 61 is interposed between the outer package film 30 and the positive electrode lead 51. The sealing film 62 is interposed between the outer package film 30 and the negative electrode lead 52. Note that the sealing film 61, the sealing film 62, or both may be omitted.

The sealing film 61 is a sealing member that prevents entry, for example, of outside air into the outer package film 30. Specifically, the sealing film 61 includes a polymer compound such as a polyolefin that has adherence to the positive electrode lead 51. Examples of the polyolefin include polypropylene.

A configuration of the sealing film 62 is similar to that of the sealing film 61 except that the sealing film 62 is a sealing member that has adherence to the negative electrode lead 52. That is, the sealing film 62 includes a polymer compound, such as a polyolefin, that has adherence to the negative electrode lead 52.

As illustrated in FIGS. 18 and 19, the battery device 40 is a power generation device that includes the positive electrode 41, the negative electrode 42, a separator 43, and the electrolytic solution (not illustrated). The battery device 40 is contained inside the outer package film 30.

The battery device 40 is what is called a wound electrode body. That is, in the battery device 40, the positive electrode 41 and the negative electrode 42 are stacked on each other with the separator 43 interposed therebetween, and the positive electrode 41, the negative electrode 42, and the separator 43 are wound about a virtual axis (a winding axis P) extending in a Y-axis direction. Thus, the positive electrode 41 and the negative electrode 42 are opposed to each other with the separator 43 interposed therebetween, and are wound.

A three-dimensional shape of the battery device 40 is not particularly limited. Here, the battery device 40 has an elongated-shaped structure. Accordingly, a section of the battery device 40 intersecting the winding axis P, that is, a section of the battery device 40 along an XZ plane, has an elongated shape defined by a major axis J1 and a minor axis J2. The major axis J1 is a virtual axis that extends in an X-axis direction and has a larger length than the minor axis J2. The minor axis J2 is a virtual axis that extends in a Z-axis direction intersecting the X-axis direction and has a smaller length than the major axis J1. Here, the battery device 40 has an elongated cylindrical three-dimensional shape. Thus, the section of the battery device 40 has an elongated, substantially elliptical shape.

The positive electrode 41 is a first electrode having a configuration similar to that of the electrode described above. That is, the positive electrode 41 includes a positive electrode current collector 41A and a positive electrode active material layer 41B. The positive electrode current collector 41A has a configuration similar to that of the current collector 1A. The positive electrode active material layer 41B has a configuration similar to that of the active material layer 1B. Note that FIG. 19 omits illustration of a component corresponding to the protective member 2 for simplification of illustration contents.

The positive electrode current collector 41A has two opposed surfaces on each of which the positive electrode active material layer 41B is to be provided. The positive electrode current collector 41A includes an electrically conductive material such as a metal material. Examples of the metal material include aluminum.

Here, the positive electrode active material layer 41B is provided on each of the two opposed surfaces of the positive electrode current collector 41A. The positive electrode active material layer 41B includes one or more of positive electrode active materials into which lithium is insertable and from which lithium is extractable. Note that the positive electrode active material layer 41B may be provided only on one of the two opposed surfaces of the positive electrode current collector 41A on a side where the positive electrode 41 is opposed to the negative electrode 42. In addition, the positive electrode active material layer 41B may further include one or more of other materials including, without limitation, a positive electrode binder and a positive electrode conductor. A method of forming the positive electrode active material layer 41B is not particularly limited, and specifically includes one or more of methods including, without limitation, a coating method.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

Details of the positive electrode binder are similar to those of the binder described above. Details of the positive electrode conductor are similar to those of the conductor described above.

The negative electrode 42 is a second electrode that includes, as illustrated in FIG. 19, a negative electrode current collector 42A and a negative electrode active material layer 42B.

The negative electrode current collector 42A has two opposed surfaces on each of which the negative electrode active material layer 42B is to be provided. The negative electrode current collector 42A includes an electrically conductive material such as a metal material. Examples of the metal material include copper.

Here, the negative electrode active material layer 42B is provided on each of the two opposed surfaces of the negative electrode current collector 42A. Note that the negative electrode active material layer 42B may be provided only on one of the two opposed surfaces of the negative electrode current collector 42A on a side where the negative electrode 42 is opposed to the positive electrode 41. A method of forming the negative electrode active material layer 42B is not particularly limited, and specifically includes one or more of methods including, without limitation, a coating method, a vapor-phase method, a liquid-phase method, a thermal spraying method, and a firing (sintering) method.

The negative electrode active material layer 42B includes one or more of negative electrode active materials into which lithium is insertable and from which lithium is extractable. Note that the negative electrode active material layer 42B may further include materials including, without limitation, a negative electrode binder and a negative electrode conductor. Details of the negative electrode binder are similar to those of the positive electrode binder. Details of the negative electrode conductor are similar to those of the positive electrode conductor.

The negative electrode active material includes a carbon material, a metal-based material, or both, for example. A reason for this is that a high energy density is obtainable. Examples of the carbon material include graphitizable carbon, non-graphitizable carbon, and graphite (natural graphite and artificial graphite). The metal-based material is a material that includes, as one or more constituent elements, one or more elements among metal elements and metalloid elements that are each able to form an alloy with lithium. Specific examples of such metal elements and metalloid elements include silicon, tin, or both. Note that the metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

An area of the negative electrode active material layer 42B defined based on a width and a length (a lateral dimension and a vertical dimension) is preferably greater than an area of the positive electrode active material layer 41B defined based on a dimension of a width and a dimension of a length. To give an example, the width of the negative electrode active material layer 42B is preferably greater by 1 mm or more than the width of the positive electrode active material layer 41B on each of both sides (left and right sides) in a width direction. In addition, the length of the negative electrode active material layer 42B is preferably greater by 1 mm or more than the length of the positive electrode active material layer 41B on each of both sides (front and rear sides) in a length direction. This is to prevent lithium that has been extracted from the positive electrode 41 from precipitating on a surface of the negative electrode 42.

As illustrated in FIG. 19, the separator 43 is a first separator interposed between the positive electrode 41 and the negative electrode 42. The separator 43 is an insulating porous film that allows lithium ions to pass therethrough while preventing contact (a short circuit) between the positive electrode 41 and the negative electrode 42. The separator 43 includes a polymer compound such as polyethylene.

The positive electrode 41, the negative electrode 42, and the separator 43 are each impregnated with the electrolytic solution, and the electrolytic solution includes a solvent and an electrolyte salt. The solvent includes one or more of non-aqueous solvents (organic solvents) including, without limitation, a carbonic-acid-ester-based compound, a carboxylic-acid-ester-based compound, and a lactone-based compound. The electrolytic solution including the one or more non-aqueous solvents is what is called a non-aqueous electrolytic solution. The electrolyte salt includes one or more of light metal salts including, without limitation, a lithium salt.

As illustrated in FIG. 18, the positive electrode lead 51 is a positive electrode terminal coupled to the positive electrode 41, more specifically to the positive electrode current collector 41A. The positive electrode lead 51 is led to an outside of the outer package film 30, and includes an electrically conductive material such as aluminum. The positive electrode lead 51 is not particularly limited in shape, and specifically has any of shapes including, without limitation, a thin plate shape and a meshed shape.

As illustrated in FIG. 18, the negative electrode lead 52 is a negative electrode terminal coupled to the negative electrode 42, more specifically to the negative electrode current collector 42A. The negative electrode lead 52 is led to the outside of the outer package film 30, and includes an electrically conductive material such as copper. Here, the negative electrode lead 52 is led out in a direction similar to that in which the positive electrode lead 51 is led out. Note that details of a shape of the negative electrode lead 52 are similar to those of the shape of the positive electrode lead 51.

Upon charging the secondary battery, in the battery device 40, lithium is extracted from the positive electrode 41, and the extracted lithium is inserted into the negative electrode 42 via the electrolytic solution. Upon discharging the secondary battery, in the battery device 40, lithium is extracted from the negative electrode 42, and the extracted lithium is inserted into the positive electrode 41 via the electrolytic solution. Upon charging and discharging, lithium is inserted and extracted in an ionic state.

In a case of manufacturing the secondary battery, the positive electrode 41 and the negative electrode 42 are each fabricated and the electrolytic solution is prepared, following which the secondary battery is fabricated using the positive electrode 41, the negative electrode 42, and the electrolytic solution, according to a procedure to be described below.

The positive electrode 41 is manufactured by a procedure similar to the manufacturing procedure of the electrode described above. Specifically, first, a mixture (a positive electrode mixture) in which materials including, without limitation, the positive electrode active material, the positive electrode binder, and the positive electrode conductor are mixed with each other is put into a solvent to thereby prepare a positive electrode mixture slurry in a paste form. Thereafter, the positive electrode mixture slurry is applied on the two opposed surfaces of the positive electrode current collector 41A to thereby form the positive electrode active material layers 41B. Thereafter, the positive electrode active material layers 41B may be compression-molded by means of, for example, a roll pressing machine. In this case, the positive electrode active material layers 41B may be heated. The positive electrode active material layers 41B may be compression-molded multiple times.

The positive electrode active material layers 41B are thus formed on the two respective opposed surfaces of the positive electrode current collector 41A. As a result, a positive electrode body is formed. Although not specifically illustrated here, the positive electrode body is a structure body corresponding to the electrode body 1, and includes the positive electrode current collector 41A and the positive electrode active material layers 41B corresponding to the current collector 1A and the active material layers 1, respectively.

Lastly, the protective members 190 (each including the unadhered part 2X and the paired adhered parts 2Y) are adhered to two opposed surfaces of the positive electrode body, following which the positive electrode body is cut together with the protective members 190 at the unadhered parts 2X. In such a manner, the positive electrode 41 including the positive electrode body and the protective members 2, that is, the positive electrode 41 corresponding to the electrode 10 including the electrode body 1 and the protective members 2 is fabricated.

First, a mixture (a negative electrode mixture) in which materials including, without limitation, the negative electrode active material, the negative electrode binder, and the negative electrode conductor are mixed with each other is put into a solvent to thereby prepare a negative electrode mixture slurry in a paste form. Thereafter, the negative electrode mixture slurry is applied on the two opposed surfaces of the negative electrode current collector 42A to thereby form the negative electrode active material layers 42B. Needless to say, the negative electrode active material layers 42B may be compression-molded. The negative electrode active material layers 42B are thus formed on the two respective opposed surfaces of the negative electrode current collector 42A. As a result, the negative electrode 42 is fabricated.

The electrolyte salt is put into a solvent. The electrolyte salt is thus dispersed or dissolved in the solvent. As a result, the electrolytic solution is prepared.

First, the positive electrode lead 51 is coupled to the positive electrode current collector 41A of the positive electrode 41 by a method such as a welding method, and the negative electrode lead 52 is coupled to the negative electrode current collector 42A of the negative electrode 42 by a method such as a welding method.

Thereafter, the positive electrode 41 and the negative electrode 42 are stacked on each other with the separator 43 interposed therebetween, following which the stack of the positive electrode 41, the negative electrode 42, and the separator 43 is wound to thereby fabricate the wound body. Although not specifically illustrated here, the wound body has a configuration similar to that of the battery device 40 except that the positive electrode 41, the negative electrode 42, and the separator 43 are each unimpregnated with the electrolytic solution. Thereafter, the wound body is pressed by means of, for example, a pressing machine to thereby shape the wound body into an elongated shape.

Thereafter, the wound body is placed inside the depression part 30U, following which the outer package film 30 (the fusion-bonding layer/the metal layer/the surface protective layer) is folded to thereby cause portions of the outer package film 30 to be opposed to each other. Thereafter, outer edge parts of two sides of the outer package film 30 (the fusion-bonding layer) opposed to each other are bonded to each other by a method such as a thermal-fusion-bonding method to thereby place the wound body inside the outer package film 30 having the pouch shape.

Lastly, the electrolytic solution is injected into the outer package film 30 having the pouch shape, following which outer edge parts of the remaining one side of the outer package film 30 (the fusion-bonding layer) are bonded to each other by a method such as a thermal-fusion-bonding method. In this case, the sealing film 61 is interposed between the outer package film 30 and the positive electrode lead 51, and the sealing film 62 is interposed between the outer package film 30 and the negative electrode lead 52. The wound body is thereby impregnated with the electrolytic solution, and the battery device 40 that is a wound electrode body is thus fabricated. In addition, the battery device 40 is sealed in the outer package film 30 having the pouch shape. As a result, the secondary battery is assembled.

The assembled secondary battery is charged and discharged. Various conditions including, without limitation, an environment temperature, the number of times of charging and discharging (the number of cycles), and charging and discharging conditions may be set as desired. As a result, a film is formed on a surface of each of the positive electrode 41 and the negative electrode 42, which electrochemically stabilizes a state of the secondary battery. As a result, the secondary battery is completed.

According to the secondary battery, the positive electrode 41 has a configuration similar to that of the electrode described above. Accordingly, for reasons similar to those in the case described in relation to the electrode, a high volume energy density is achieved, stable manufacturing of the positive electrode 41 is facilitated, and in addition, a short circuit is prevented from easily occurring. It is therefore possible to achieve a superior capacity characteristic, superior safety, and superior manufacturing stability.

In particular, the positive electrode 41 may be wound. More specifically, the positive electrode 41 may be opposed to the negative electrode 42 with the separator 43 interposed therebetween and wound. This effectively suppresses occurrence of a short circuit even if the positive electrode 41 is closely attached to the negative electrode 42 with the separator 43 interposed therebetween. Accordingly, it is possible to achieve higher effects.

Other action and effects of the secondary battery are similar to those of the electrode described above.

The configuration of each of the electrode and the secondary battery described herein is appropriately modifiable including as described below according to an embodiment. Note that any of the following series of modifications may be combined with each other.

In FIG. 1, the active material layer 1B is provided on the current collector 1A from the position corresponding to the exposed face 1AR. Therefore, the unadhered part 2X is not present beyond the position corresponding to the exposed face 1AR. Accordingly, a portion of the unadhered part 2X does not cover a portion of the exposed face 1BR, which makes the entire exposed face 1BR exposed.

However, as illustrated in FIG. 20 corresponding to FIG. 1, the protective member 2 (the unadhered part 2X) may be present beyond the position corresponding to the exposed face 1AR, and a portion of the unadhered part 2X may thus cover a portion of the exposed face 1BR. That is, a portion of the exposed face 1BR may be covered with the unadhered part 2X, and the remaining portion of the exposed face 1BR may thus be exposed.

In a case of forming the protective member 2 including such an unadhered part 2X, for example, a material property such as elongation of the base layer 2A, a kind of the cutting blade, and cutting conditions are adjusted. The cutting condition includes, for example, a cutting angle and a cutting speed. A portion of the base layer 2A (the unadhered part 2X) after being cut thus extends beyond the position corresponding to the exposed face 1AR in response to stress at the time of cutting. As a result, a portion of the base layer 2A covers a portion of the active material layer 1, and the portion of the base layer 2A is closely attached to the exposed face 1BR by using, for example, electrostatic force.

In this case, as compared with the case illustrated in FIG. 1, not only the upper surface or the lower surface of the active material layer 1B but also the side surface (the exposed face 1BR) of the active material layer 1B is protected by the protective member 2. This further suppresses occurrence of a short circuit, therefore further improving safety. Accordingly, it is possible to achieve higher effects.

In FIG. 14, the active material layer 1B on the upper side is provided on the current collector 1A from the position recessed relative to the position corresponding to the exposed face 1AR, and the active material layer 1B on the lower side is also provided on the current collector 1A from the position recessed relative to the position corresponding to the exposed face 1AR.

However, as illustrated in FIG. 21 corresponding to FIG. 14, the active material layer 1B on the upper side may be provided on the current collector 1A from the position recessed relative to the position corresponding to the exposed face 1AR, and the active material layer 1B on the lower side may be provided on the current collector 1A from the position corresponding to the exposed face 1AR. The configuration of the active material layer 1B on the lower side is similar to that of the active material layer 1B on the lower side illustrated in FIG. 1. The configuration of each of the protective members 2 on the lower side is similar to that of each of the protective members 2 on the lower side illustrated in FIG. 1. The configuration of the active material layer 1B on the upper side is similar to that of the active material layer 1B on the upper side illustrated in FIG. 14. The configuration of each of the protective members 2 on the upper side is similar to that of each of the protective members 2 on the upper side illustrated in FIG. 14.

Although not specifically illustrated here, the electrode body 1 including the active material layer 1B on the upper side and the active material layer 1B on the lower side is formed as follows. The active material layer 1B on the lower side is formed by a procedure similar to the procedure of forming the electrode body 1 illustrated in FIG. 1, i.e., by continuously applying the mixture slurry. In addition, the active material layer 1B on the upper side is formed by a procedure similar to the procedure of forming the electrode body 1 illustrated in FIG. 14, i.e., by intermittently applying the mixture slurry.

In this case also, as with the case illustrated in each of FIGS. 1 and 14, a high energy density is achieved, stable manufacturing of the electrode 20 is facilitated, and a short circuit is prevented from easily occurring. It is therefore possible to achieve a superior capacity characteristic, superior safety, and superior manufacturing stability.

Note that although not specifically illustrated here, it goes without saying that the active material layer 1B on the upper side may be provided on the current collector 1A from the position corresponding to the exposed face 1AR, and the active material layer 1B on the lower side may be provided on the current collector 1A from the position recessed relative to the position corresponding to the exposed face 1AR. It is possible to achieve similar effects also in this case.

In FIG. 1, the electrode 10 includes four protective members 2. That is, the electrode 10 includes two protective members 2 provided on the upper surface of the electrode body 1, and two protective members 2 provided on the lower surface of the electrode body 1. This makes it possible to achieve a superior capacity characteristic, superior safety, and superior manufacturing stability, as compared with a case where the electrode 10 includes no protective member 2, as described above.

In particular, in a case where the protective members 2 are provided on both of two opposed surfaces (the upper surface and the lower surface) of the electrode body 1, in the secondary battery using the electrode 10 as the positive electrode 41, the positive electrode 41 is wound and thus the protective members 2 cover the surface of the positive electrode body on each of an inner side of winding and an outer side of the winding. Accordingly, the corner parts of the positive electrode active material layers 41B are covered with the protective members 2 on each of the upper and lower surfaces of the positive electrode 41. This further prevents a short circuit from easily occurring. Accordingly, it is possible to achieve higher effects.

Note that the “inner side of the winding” refers to, in a case where the positive electrode 41 is wound about a winding center (a center point C) to be described later, a side closer to the winding center of the positive electrode 41. The “outer side of the winding” refers to an opposite side to the inner side of the winding, that is, a side farther from the winding center of the positive electrode 41.

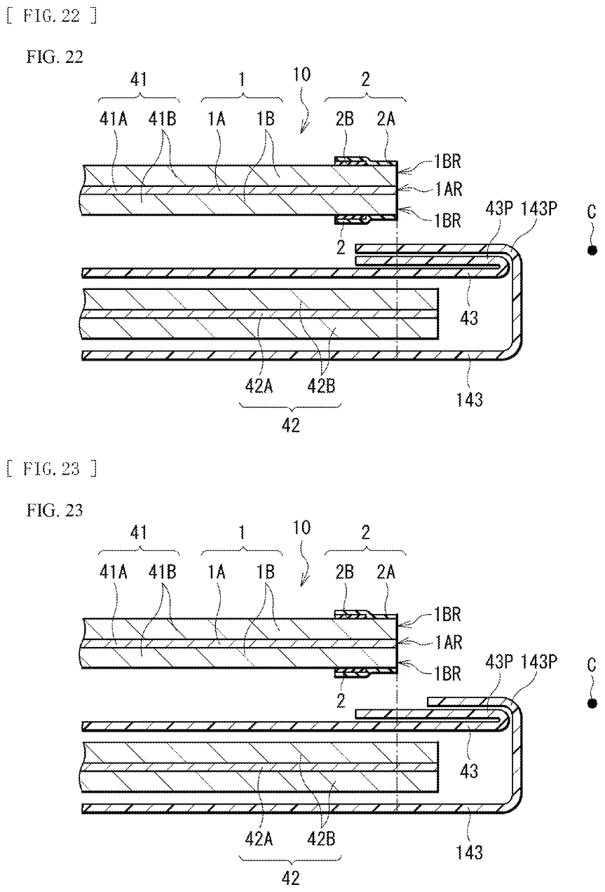

In this case, as illustrated in FIG. 22 corresponding to FIGS. 1 and 19, it is preferable that the separator 43 be interposed between the positive electrode 41 and the negative electrode 42, and that the separator 43 be thus opposed to the positive electrode 41 and wound and that a leading end part 43P of the separator 43 be folded back to overlap with the protective member 2 in the vicinity of the winding center of the battery device 40.

Note that FIG. 22 includes the reference numerals related to the electrode 10 in addition to the reference numerals related to the positive electrode 41 for easier understanding of a corresponding relationship between the configuration of the electrode 10 and the configuration of the positive electrode 41. In addition, FIG. 22 illustrates a state in which the positive electrode 41, the negative electrode 42, and the separator 43 are separated from each other so that the configuration of each of the positive electrode 41, the negative electrode 42, and the separator 43 is easier to see.

In more detail, as illustrated in FIG. 22, the positive electrode 41 and the negative electrode 42 are opposed to each other with the separator 43 interposed therebetween and are wound. Here, the negative electrode 42 has a length greater than that of the positive electrode 41. Therefore, the negative electrode 42 protrudes relative to the positive electrode 41 toward the winding center. The winding center refers to the center in a case where the positive electrode 41 and the negative electrode 42 are opposed to each other with the separator 43 interposed therebetween and are wound. In other words, the winding center is the virtual center point C located at the center of the battery device 40. A reason why the length of the negative electrode 42 is greater than the length of the positive electrode 41 is to prevent lithium extracted from the positive electrode 41 during charging from being unintentionally precipitated on the surface of the negative electrode 42. Note that a length of a portion of the negative electrode 42 protruding relative to the positive electrode 41 is not particularly limited, and may be set as desired.

The separator 43 has a length greater than the length of the positive electrode 41. More specifically, the length of the separator 43 is greater than the length of the negative electrode 42. The separator 43 thus protrudes relative to each of the positive electrode 41 and the negative electrode 42 toward the winding center. Accordingly, the separator 43 includes the leading end part 43P protruding relative to the positive electrode 41 toward the winding center.

The leading end part 43P is a first leading end part that extends toward the winding center and is thereafter folded back to extend away from the winding center. The leading end part 43P overlaps with the protective member 2. Note that the leading end part 43P may overlap with all of the protective member 2, or may overlap with a portion of the protective member 2. FIG. 22 illustrates a case where the leading end part 43P overlaps with a portion of the protective member 2.

The protective member 2 with which the leading end part 43P overlaps is the protective member 2 provided on the lower surface of the positive electrode body, that is, the protective member 2 disposed on a side where the separator 43 is opposed to the positive electrode 41, among the protective members 2 provided on the two opposed surfaces (the upper surface and the lower surface) of the positive electrode body. The protective member 2 with which the leading end part 43P overlaps may be the protective member 2 covering the surface of the positive electrode body on the inner side of the winding, or may be the protective member 2 covering the surface of the positive electrode body on the outer side of the winding.

Note that the protective member 2 with which the leading end part 43P overlaps may be the protective member 2 provided on the upper surface of the positive electrode body, that is, the protective member 2 disposed on an opposite side to the side where the separator 43 is opposed to the positive electrode 41. The protective member 2 with which the leading end part 43P overlaps may be the protective member 2 covering the surface of the positive electrode body on the inner side of the winding, or may be the protective member 2 covering the surface of the positive electrode body on the outer side of the winding.

In this case, the corner part of the positive electrode active material layer 41B is protected also by the separator 43 in addition to the protective member 2. In addition, if the separator 43 has a sufficiently small thickness, capacity loss is not increased too much, which makes it possible to obtain a sufficient capacity. This further prevents a short circuit from easily occurring, while securing the capacity. Accordingly, it is possible to achieve higher effects.

Needless to say, the advantages described here are similarly achievable also in a case applied to the electrode 20 (FIG. 14).

Note that in the case illustrated in FIG. 22, the secondary battery may further include a separator 143, and a leading end part 143P of the separator 143 may be folded back to overlap with the protective member 2, as with the leading end part 43P.

In more detail, as illustrated in FIG. 22, the negative electrode 42 is a second electrode having a polarity (a negative polarity) opposite to a polarity (a positive polarity) of the positive electrode 41. The negative electrode 42 is opposed to the positive electrode 41 with the separator 43 interposed therebetween and is wound. The separator 143 is a second separator that is opposed to the separator 43 with the negative electrode 42 interposed therebetween and is wound. The separator 143 has a configuration similar to that of the separator 43. The negative electrode 42 is thus insulated from the positive electrode 41 by means of the separators 43 and 143 although the negative electrode 42 is wound together with the positive electrode 41.

As with the length of the separator 43, a length of the separator 143 is greater than the length of the positive electrode 41. More specifically, the length of the separator 143 is greater than the length of the negative electrode 42. The separator 143 thus protrudes relative to each of the positive electrode 41 and the negative electrode 42 toward the winding center. Accordingly, the separator 143 includes the leading end part 143P protruding relative to the positive electrode 41 toward the winding center.

The leading end part 143P is a second leading end part corresponding to the leading end part 43P. That is, as with the leading end part 43P, the leading end part 143P extends toward the winding center and is thereafter folded back to extend away from the winding center. The leading end part 143P thus overlaps with the protective member 2. Note that the leading end part 143P may overlap with all of the protective member 2, or may overlap with a portion of the protective member 2. As described above, the leading end parts 43P and 143P each overlap with the protective member 2.

In this case, the corner part of the positive electrode active material layer 41B is protected also by the separator 143. In addition, if the separator 143 has a sufficiently small thickness, capacity loss is not increased too much, which makes it possible to obtain a sufficient capacity. This further prevents a short circuit from easily occurring, while securing the capacity. Accordingly, it is possible to achieve further higher effects.

Note that in the case illustrated in FIG. 22, as illustrated in FIG. 23 corresponding to FIG. 22, the leading end part 143P may not overlap with the protective member 2 while the leading end part 43P overlaps with the protective member 2. In this case, the leading end part 143P extends toward the winding center and is thereafter folded back to extend away from the winding center, but terminates not to overlap with the protective member 2.

In this case also, the corner part of the positive electrode active material layer 41B is protected by the protective member 2. This further prevents a short circuit from easily occurring, while securing the capacity. Accordingly, it is possible to achieve higher effects. However, to further suppress the occurrence of a short circuit, it is preferable that both the leading end parts 43P and 143P overlap with the protective member 2.

In FIG. 1, the electrode 10 includes four protective members 2. However, the number of the protective members 2 is not particularly limited, and may be changed as desired.

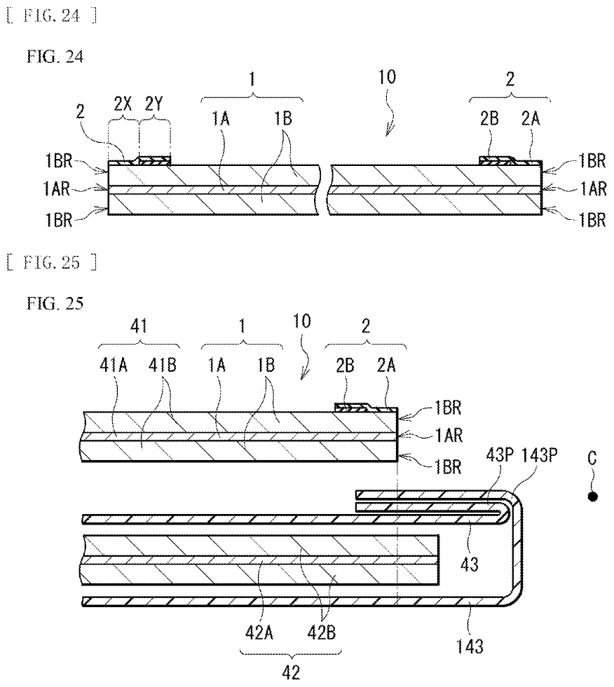

Specifically, as illustrated in FIG. 24 corresponding to FIG. 1, the electrode 10 may include only two protective members 2 provided on the upper surface of the electrode body 1. In this case also, a short circuit is prevented from easily occurring as compared with the case where the electrode 10 includes no protective member 2. It is therefore possible to achieve a superior capacity characteristic, superior safety, and superior manufacturing stability.

Note that although not specifically illustrated here, the electrode 10 may include only two protective members 2 provided on the lower surface of the electrode body 1. Alternatively, the electrode 10 may include only one protective member 2 selected as desired from among the four protective members 2, or may include any three protective members 2 selected as desired from among the four protective members 2.

This modification described here may be applied to the electrode 20 (FIG. 14).

In particular, in a case where the protective members 2 are provided on only one of the two opposed surfaces (on the upper surface or the lower surface) of the electrode body 1 as illustrated in FIG. 24, in the secondary battery using the electrode 10 as the positive electrode 41, the positive electrode 41 is wound and thus the protective members 2 cover the surface of the positive electrode body on the inner side of the winding or the outer side of the winding. That is, in the case where the protective members 2 are provided on only one of the two opposed surfaces (on the upper surface or the lower surface) of the positive electrode body, the positive electrode 41 may be so wound that the protective members 2 are disposed on the inner side of the winding, or may be so wound that the protective members 2 are disposed on the outer side of the winding.

In either of the above-described cases, the volume energy density of the positive electrode 41 increases by an amount corresponding to a decrease in volume occupied by the protective members 2, as compared with the case (FIG. 1) where the protective members 2 are provided on both the two opposed surfaces (the upper surface and the lower surface) of the positive electrode body. The capacity thus further increases in accordance with a decrease in capacity loss. Accordingly, it is possible to achieve higher effects.

Note that in the case illustrated in FIG. 24, as illustrated in FIG. 25 corresponding to FIGS. 22 and 24, the leading end part 43P of the separator 43 may be folded back to overlap with the protective member 2. The protective member 2 with which the leading end part 43P overlaps is the protective member 2 covering the surface of the positive electrode body on an opposite side (the upper side) to the side (the lower side) where the separator 43 is opposed to the positive electrode 41. A leading end vicinity portion of the leading end part 43P is disposed between the positive electrode 41 and the negative electrode 42. The leading end part 43P thus overlaps with the protective member 2 without being in contact with the protective member 2. Details of the leading end part 43P are as described above.

In this case also, the corner parts of the positive electrode active material layer 41B are protected also by the separator 43 in addition to the protective member 2, as described above. This further prevents a short circuit from easily occurring, while securing the capacity. Accordingly, it is possible to achieve higher effects.

Note that in the case illustrated in FIG. 25, the secondary battery may further include the separator 143, and the leading end part 143P of the separator 143 may be folded back to overlap with the protective member 2, as with the leading end part 43P. Details of each of the separator 143 and the leading end part 143P are as described above.

In this case also, the corner parts of the positive electrode active material layers 41B are further protected by the separator 143, as described above. This still further prevents a short circuit from easily occurring, while securing the capacity. Accordingly, it is possible to achieve further higher effects.

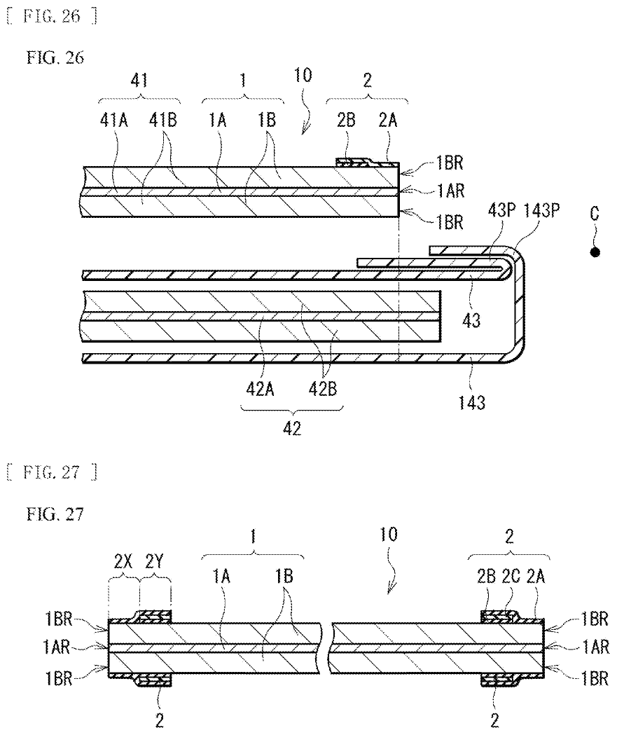

Note that in the case illustrated in FIG. 25, as illustrated in FIG. 26 corresponding to FIG. 25, the leading end part 143P may not overlap with the protective member 2 while the leading end part 43P overlaps with the protective member 2.

In this case also, the corner parts of the positive electrode active material layer 41B may be protected by the protective members 2. This further prevents a short circuit from easily occurring, while securing the capacity. Accordingly, it is possible to achieve higher effects. However, to suppress occurrence of a short circuit, it is preferable that both the leading end parts 43P and 143P overlap with the protective member 2, as described above.

In FIG. 1, the protective member 2 may include a colorant within a range corresponding to the adhered part 2Y.

Specifically, in FIG. 1, the adhesive layer 2B may include one or more of colorants. The one or more colorants are not particularly limited in kind, and may be selected as desired in accordance with a color (a desired color) of the adhesive layer 2B. Specific examples of the colorants include silicon dioxide, titanium dioxide, and a phthalocyanine-based pigment. Examples of the phthalocyanine-based pigment include phthalocyanine blue, phthalocyanine green, and phthalocyanine red.

Alternatively, as illustrated in FIG. 27 corresponding to FIG. 1, the protective member 2 may further include a colored layer 2C interposed between the base layer 2A and the adhesive layer 2B. The colored layer 2C may include one or more of colorants. Details of the colorants are as described above. Note that the colored layer 2C may include one or more of other materials including, without limitation, a binder, together with the one or more colorants.

In this case, the color of the unadhered part 2X (the base layer 2A) and the color of the adhered part 2Y (the adhesive layer 2B) differ from each other. Therefore, a light reflectance of the unadhered part 2X and a light reflectance of the adhered part 2Y differ from each other. This allows for optical measurement of a distance between the protective member 2 (the adhered part 2Y) provided at the right end part of the electrode body 1 and the protective member 2 (the adhered part 2Y) provided at the left end part of the electrode body 1. It is thus possible to optically measure the length of the electrode 10 based on the measured distance.

Needless to say, this modification described here may be applied to the electrode 20 (FIG. 14).

In the secondary battery illustrated in FIGS. 18 and 19, the separator 43, which is a porous film, is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. A reason for this is that adherence of the separator to each of the positive electrode 41 and the negative electrode 42 improves to suppress misalignment (winding displacement) of the battery device 40. This helps to prevent the secondary battery from easily swelling even if, for example, a decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation by the secondary battery, thus improving safety or heat resistance of the secondary battery. The insulating particles include an inorganic material, a resin material, or both. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

In a case of fabricating the separator of the stacked type, a precursor solution including, without limitation, the polymer compound and a solvent is prepared, following which the precursor solution is applied on one of or each of the two opposed surfaces of the porous film. In this case, the insulating particles may be added to the precursor solution on an as-needed basis.

In the case where the separator of the stacked type is used also, lithium ions are movable between the positive electrode 41 and the negative electrode 42, and similar effects are therefore obtainable. In this case, in particular, the secondary battery improves in safety, as described above. Accordingly, it is possible to achieve higher effects.

In the secondary battery illustrated in FIGS. 18 and 19, the electrolytic solution, which is a liquid electrolyte, is used. However, although not specifically illustrated here, an electrolyte layer, which is a gel electrolyte, may be used.

In the battery device 40 including the electrolyte layer, the positive electrode 41 and the negative electrode 42 are stacked on each other with the separator 43 and the electrolyte layer interposed therebetween, and the stack of the positive electrode 41, the negative electrode 42, the separator 43, and the electrolyte layer is wound. The electrolyte layer is interposed between the positive electrode 41 and the separator 43, and between the negative electrode 42 and the separator 43.

Specifically, the electrolyte layer includes a polymer compound together with the electrolytic solution. The electrolytic solution is held by the polymer compound. A reason for this is that leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and a solvent is prepared, following which the precursor solution is applied on one side or both sides of the positive electrode 41 and on one side or both sides of the negative electrode 42.

In the case where the electrolyte layer is used also, lithium ions are movable between the positive electrode 41 and the negative electrode 42 via the electrolyte layer, and similar effects are therefore obtainable. In this case, in particular, leakage of the electrolytic solution is prevented, as described above. Accordingly, it is possible to achieve higher effects.

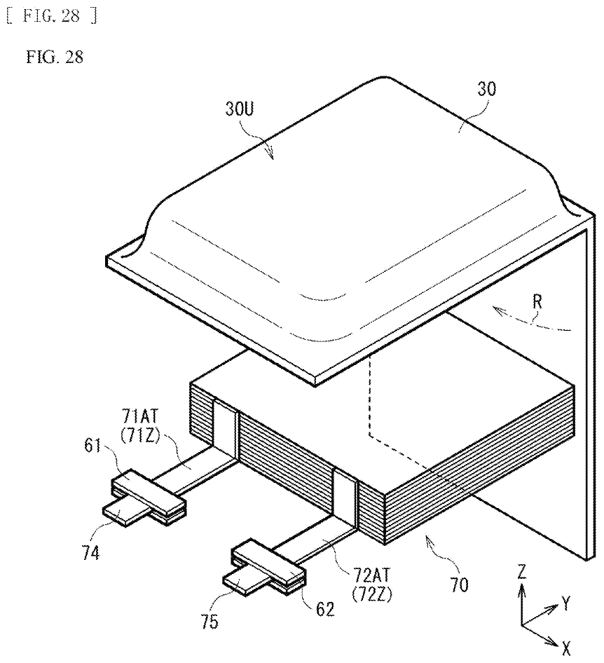

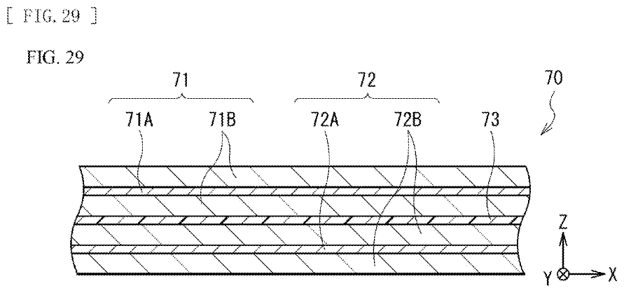

In the secondary battery illustrated in FIGS. 18 and 19, the battery device 40 that is a wound electrode body is used. However, as illustrated in FIG. 28 corresponding to FIG. 18 and in FIG. 29 corresponding to FIG. 19, a battery device 70 that is a stacked electrode body may be used.

The secondary battery of the laminated-film type illustrated in FIGS. 28 and 29 has a configuration similar to that of the secondary battery of the laminated-film type illustrated in FIGS. 18 and 19 except for including the battery device 70 (a positive electrode 71, a negative electrode 72, and a separator 73), a positive electrode lead 74, and a negative electrode lead 75 instead of the battery device 40 (the positive electrode 41, the negative electrode 42, and the separator 43), the positive electrode lead 51, and the negative electrode lead 52.

The configurations of the positive electrode 71, the negative electrode 72, the separator 73, the positive electrode lead 74, and the negative electrode lead 75 are similar to the configurations of the positive electrode 41, the negative electrode 42, the separator 43, the positive electrode lead 51, and the negative electrode lead 52, respectively, except for the points described below.

In the battery device 70, the positive electrode 71 and the negative electrode 72 are alternately stacked on each other with the separator 73 interposed therebetween. The number of the positive electrode 71, the negative electrode 72, and the separator 73 that are stacked is not particularly limited. Here, however, multiple positive electrodes 71 and the multiple negative electrodes 72 are stacked on each other with the separators 73 interposed therebetween. The positive electrodes 71, the negative electrodes 72, and the separators 73 are each impregnated with the electrolytic solution. The positive electrodes 71 each include a positive electrode current collector 71A and a positive electrode active material layer 71B. The negative electrodes 72 each include a negative electrode current collector 72A and a negative electrode active material layer 72B.

In this case also, an area of the negative electrode active material layer 72B defined based on a width and a length is preferably greater than an area of the positive electrode active material layer 71B defined based on a dimension of a width and a dimension of a length. This is to prevent lithium extracted from the positive electrode 71 from being precipitated on a surface of the negative electrode 72. Note that details of the width and the length of the negative electrode active material layer 72B are similar to those of the width and the length of the negative electrode active material layer 42B, and details of the width and the length of the positive electrode active material layer 71B are similar to those of the width and the length of the positive electrode active material layer 41B.

Note that, as illustrated in FIGS. 28 and 29, the positive electrode current collector 71A includes a projecting part 71AT in which no positive electrode active material layer 71B is provided, and the negative electrode current collector 72A includes a projecting part 72AT in which no negative electrode active material layer 72B is provided. The projecting part 72AT is disposed at a position not overlapping with the projecting part 71AT. Multiple projecting parts 71AT are joined to each other to thereby form a single joint part 71Z having a lead shape. Multiple projecting parts 72AT are joined to each other to thereby form a single joint part 72Z having a lead shape. The positive electrode lead 74 is coupled to the joint part 71Z, and the negative electrode lead 75 is coupled to the joint part 72Z.

Here, the multiple projecting parts 72AT project in a direction similar to a direction in which the multiple projecting parts 71AT project (toward the front in FIG. 28). However, although not specifically illustrated here, the multiple projecting parts 72AT may project in a direction different from the direction in which the multiple projecting parts 71AT project. More specifically, the multiple projecting parts 72AT may project in a direction (toward the back in FIG. 28) opposite to the direction in which the multiple projecting parts 71AT project.

A method of manufacturing the secondary battery of the laminated-film type illustrated in FIGS. 28 and 29 is similar to the method of manufacturing the secondary battery of the laminated-film type illustrated in FIGS. 18 and 19, except that the battery device 70 is fabricated instead of the battery device 40 and that the positive electrode lead 74 and the negative electrode lead 75 are used instead of the positive electrode lead 51 and the negative electrode lead 52.

In a case of fabricating the battery device 70, first, the positive electrode 71 is fabricated in which the positive electrode active material layer 71B is provided on each of two opposed surfaces of the positive electrode current collector 71A (excluding the projecting part 71AT), and the negative electrode 72 is fabricated in which the negative electrode active material layer 72B is provided on each of two opposed surfaces of the negative electrode current collector 72A (excluding the projecting part 72AT). Thereafter, the multiple positive electrodes 71 and the multiple negative electrodes 72 are stacked on each other with the multiple separators 73 interposed therebetween, to thereby form a stacked body.

Thereafter, the stacked body is pressed, for example, by a pressing machine in a direction in which the multiple positive electrodes 71 and the multiple negative electrodes 72 are stacked on each other with the separators 73 interposed therebetween. The stacked body is thus compression-molded. This eliminates air bubbles present inside the stacked body, and uniformizes an inter-electrode distance (a distance between the positive electrode 71 and the negative electrode 72) after impregnation with the electrolytic solution to be described later is performed.

Thereafter, the multiple projecting parts 71AT are joined to each other by a method such as a welding method to thereby form the joint part 71Z, and the multiple projecting parts 72AT are joined to each other by a method such as a welding method to thereby form the joint part 72Z. Thereafter, the positive electrode lead 74 is coupled to the joint part 71Z by a method such as a welding method, and the negative electrode lead 75 is coupled to the joint part 72Z by a method such as a welding method. Lastly, the electrolytic solution is injected into the outer package film 30 having the pouch shape and containing the stacked body, following which the outer package film 30 is sealed. The stacked body is thereby impregnated with the electrolytic solution. As a result, the battery device 70 is fabricated.

In a case of using the battery device 70 that is the stacked electrode body also, it is possible to perform charging and discharging in a manner similar to that in the case of using the battery device 40 that is the wound electrode body. It is therefore possible to achieve similar effects. In this case, in particular, even if the positive electrodes 71 and the negative electrodes 72 are pressed in the compression-molding process of the stacked body described above, a short circuit between the positive electrodes 71 and the negative electrodes 72 is prevented from easily occurring. Accordingly, it is possible to achieve higher effects.

The secondary battery illustrated in FIG. 18 has a battery structure of the laminated-film type using the outer package film 30 having flexibility. However, the battery structure of the secondary battery is not particularly limited, and may therefore be changed as desired.

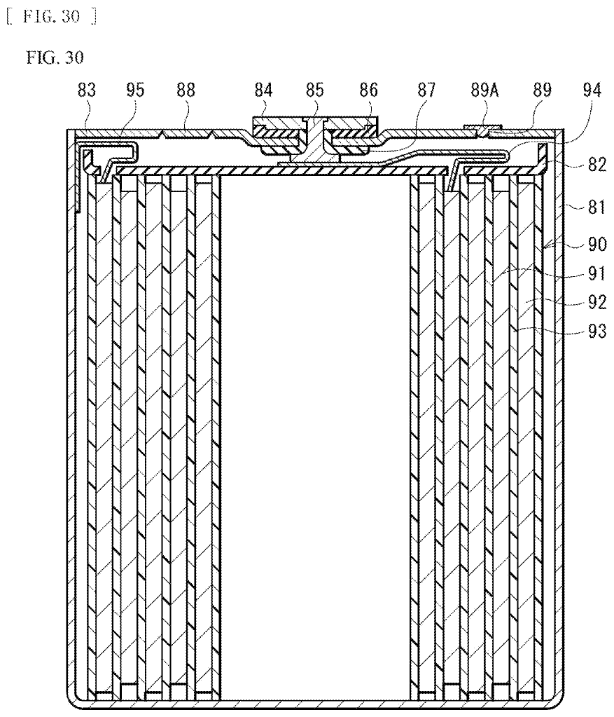

Specifically, as illustrated in FIG. 30, the structure of the secondary battery may be of a prismatic type using an outer package can 81 having rigidity. The secondary battery includes an insulating plate 82 and a battery device 90 inside the outer package can 81. The battery device 90 is a wound electrode body having an elongated shape.

The outer package can 81 is a prismatic outer package member having a hollow structure with one end part closed and another end part open. The outer package can 81 includes a metal material such as iron. An outer package cover 83 is welded to the outer package can 81. The open other end of the outer package can 81 is thus closed by the outer package cover 83. The insulating plate 82 is disposed between the outer package cover 83 and the battery device 90. The insulating plate 82 includes an insulating material such as polypropylene. The outer package cover 83 includes a material similar to that included in the outer package can 81.

A terminal plate 84 is disposed on an outer side of the outer package cover 83. The terminal plate 84 serves as a positive electrode terminal. The terminal plate 84 is electrically insulated from the outer package cover 83 by means of an insulating case 86. The insulating case 86 includes an insulating material such as polybutylene terephthalate. In addition, the outer package cover 83 has a through hole in which a positive electrode pin 85 is disposed. The positive electrode pin 85 is electrically coupled to the terminal plate 84, and is electrically insulated from the outer package cover 83 by means of an insulating gasket 87.

Note that the outer package cover 83 is provided with a cleavage valve 88 and an injection hole 89. The cleavage valve 88 is separated from the outer package cover 83 when an internal pressure of the outer package can 81 reaches a certain level or higher due to, for example, an internal short circuit. This allows the internal pressure to be released when the internal pressure increases. The injection hole 89 is closed by a sealing member 89A. The sealing member 89A includes, for example, a stainless steel ball.

The configuration of the battery device 90 (a positive electrode 91, a negative electrode 92, and a separator 93) is similar to that of the battery device 40 (the positive electrode 41, the negative electrode 42, and the separator 43). A positive electrode lead 94 is coupled to the positive electrode 91, and is also coupled to the positive electrode pin 85. A negative electrode lead 95 is coupled to the negative electrode 92, and is also coupled to the outer package can 81. The outer package can 81 thus serves as a negative electrode terminal.

An extending direction of a through hole (a space provided at a winding center of the battery device 90) provided through the battery device 90 is the same as a direction in which the outer package cover 83 is welded to the outer package can 81, in other words, a direction in which the battery device 90 is contained inside the outer package can 81. That is, the extending direction of the through hole corresponds to a vertical direction in FIG. 30, and a welding direction (a containing direction) also corresponds to the vertical direction.

The secondary battery of the prismatic type is chargeable and dischargeable in a manner similar to that of the secondary battery of the laminated-film type. It is therefore possible to achieve similar effects.

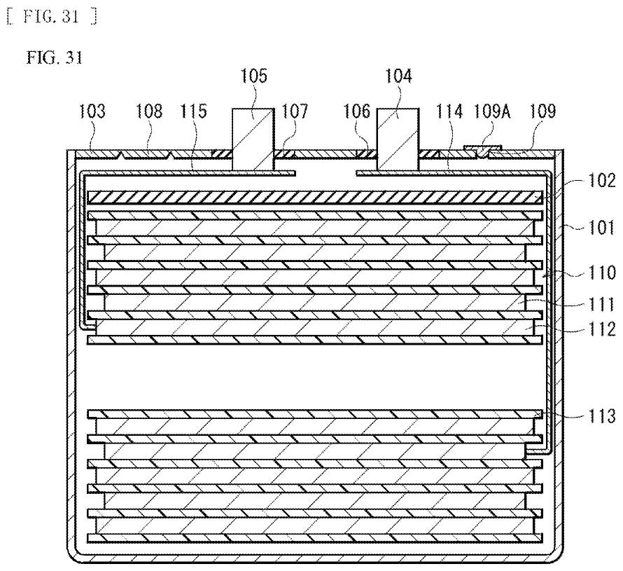

Note that the secondary battery of the prismatic type may have a configuration illustrated in FIG. 31. The secondary battery includes an insulating plate 102 and a battery device 110 inside an outer package can 101. The battery device 110 is a wound electrode body having an elongated shape.

The configurations of the outer package can 101, the insulating plate 102, an outer package cover 103, a cleavage valve 108, and an injection hole 109 (a sealing member 109A) are similar to the configurations of the outer package can 81, the insulating plate 82, the outer package cover 83, the cleavage valve 88, and the injection hole 89 (the sealing member 89A), respectively.

The outer package cover 103 has two respective through holes in which a positive electrode terminal 104 and a negative electrode terminal 105 are disposed. The positive electrode terminal 104 is electrically insulated from the outer package cover 103 by means of a gasket 106, and the negative electrode terminal 105 is electrically insulated from the outer package cover 103 by means of a gasket 107. The gaskets 106 and 107 each include an insulating material such as polybutylene terephthalate.

The configuration of the battery device 110 (a positive electrode 111, a negative electrode 112, and a separator 113) is similar to the configuration of the battery device 40 (the positive electrode 41, the negative electrode 42, and the separator 43). A positive electrode lead 114 is coupled to the positive electrode 111, and is also coupled to the positive electrode terminal 104. A negative electrode lead 115 is coupled to the negative electrode 112, and is also coupled to the negative electrode terminal 105. Note that the positive electrode lead 114 may be integrated with a positive electrode current collector of the positive electrode 111, and the negative electrode lead 115 may be integrated with a negative electrode current collector of the negative electrode 112.

An extending direction of a through hole (a space provided at a winding center of the battery device 110) provided through the battery device 110 is different from a direction in which the outer package cover 103 is welded to the outer package can 101. That is, the extending direction of the through hole is a left-right direction in FIG. 31, while the welding direction is an upper-lower direction in FIG. 31.

The extending direction of the through hole (the space provided at the winding center of the battery device 110) provided through the battery device 110 is a direction different from the direction in which the outer package cover 103 is welded to the outer package can 101, in other words, different from a direction that is the same as a direction in which the battery device 110 is contained inside the outer package can 101. That is, the extending direction of the through hole corresponds to a lateral direction in FIG. 31, while the welding direction (a containing direction) corresponds to a vertical direction in FIG. 31.

The secondary battery of the prismatic type described above is chargeable and dischargeable in a manner similar to that of the secondary battery of the laminated-film type. It is therefore possible to achieve similar effects.

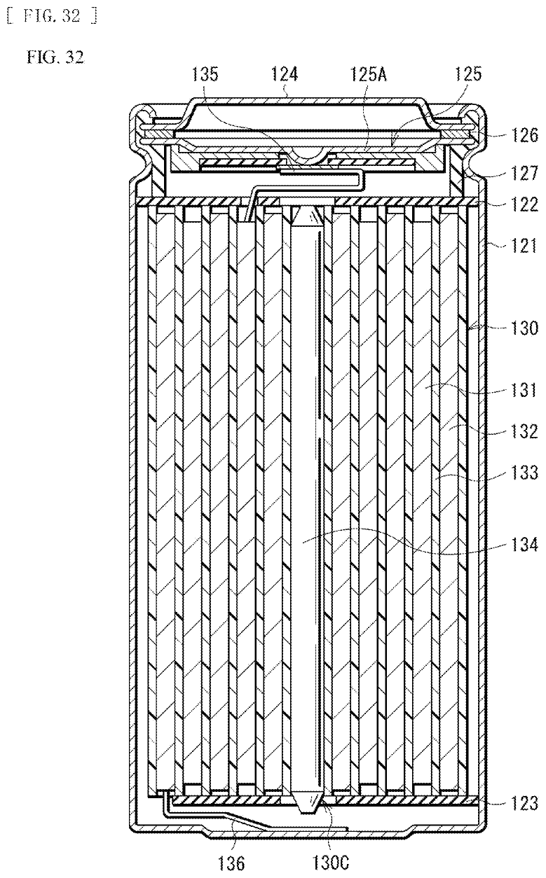

Moreover, as illustrated in FIG. 32, the structure of the secondary battery may be of a cylindrical type using an outer package can 121 having rigidity. The secondary battery includes a pair of insulating plates 122 and 123 and a battery device 130 inside the outer package can 121. The battery device 130 is a wound electrode body.

The outer package can 121 is a cylindrical outer package member having a hollow structure with one end part closed and another end part open. The outer package can 121 includes one or more of metal materials including, without limitation, iron, aluminum, an iron alloy, and an aluminum alloy. The insulating plates 122 and 123 are opposed to each other with the battery device 130 interposed therebetween.

An outer package cover 124, a safety valve mechanism 125, and a thermosensitive resistive device (PTC device) 126 are crimped at the open one end part of the outer package can 121 via an insulating gasket 127. The one end part of the outer package can 121 is thus closed by the outer package cover 124. The outer package cover 124 includes a material similar to that included in the outer package can 121. The safety valve mechanism 125 and the PTC device 126 are each disposed on an inner side of the outer package cover 124. The safety valve mechanism 125 is electrically coupled to the outer package cover 124 via the PTC device 126.

In the safety valve mechanism 125, a disk plate 125A inverts when an internal pressure of the outer package can 121 reaches a certain level or higher due to an event such as an internal short circuit, thereby cutting off electrical coupling between the outer package cover 124 and the battery device 130. In order to prevent abnormal heat generation resulting from a large current, the PTC device 126 increases in electric resistance with a rise in temperature.

The configuration of the battery device 130 (a positive electrode 131, a negative electrode 132, and a separator 133) is similar to the configuration of the battery device 40 (the positive electrode 41, the negative electrode 42, and the separator 43). A center pin 134 is disposed in a space 130C provided at a winding center of the battery device 130. A positive electrode lead 135 is coupled to the positive electrode 131, and is also coupled to the outer package cover 124 via the safety valve mechanism 125. A negative electrode lead 136 is coupled to the negative electrode 132, and is also coupled to the outer package can 121.

The secondary battery of the cylindrical type described above is chargeable and dischargeable in a manner similar to that of the secondary battery of the laminated-film type. It is therefore possible to achieve similar effects.

Applications (application examples) of the battery are not particularly limited. In the following, applications of the secondary battery as some applications of the battery will be described. Note that applications of the electrode are similar to those of the battery and are therefore described together below.

The secondary battery used as a power source may serve as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery packs may each include a single battery, or may each include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery which is an electric power storage source may be utilized for using, for example, home appliances.

An example of the application of the secondary battery will now be described in detail. The configuration of the application described below is merely an example, and is appropriately modifiable.

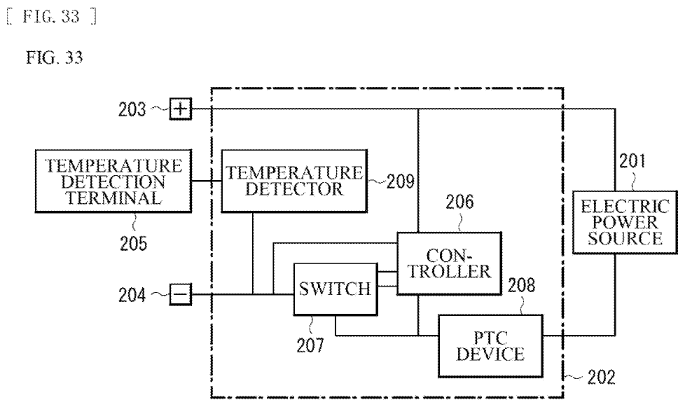

FIG. 33 illustrates a block configuration of a battery pack. The battery pack described here is a battery pack (what is called a soft pack) including one secondary battery, and is to be mounted on, for example, electronic equipment typified by a smartphone.

As illustrated in FIG. 33, the battery pack includes an electric power source 201 and a circuit board 202. The circuit board 202 is coupled to the electric power source 201, and includes a positive electrode terminal 203, a negative electrode terminal 204, and a temperature detection terminal 205.

The electric power source 201 includes one secondary battery. The secondary battery has a positive electrode lead coupled to the positive electrode terminal 203 and a negative electrode lead coupled to the negative electrode terminal 204. The electric power source 201 is couplable to outside via the positive electrode terminal 203 and the negative electrode terminal 204, and is thus chargeable and dischargeable. The circuit board 202 includes a controller 206, a switch 207, a thermosensitive resistive device (a PTC device) 208, and a temperature detector 209. However, the PTC device 208 may be omitted.

The controller 206 includes, for example, a central processing unit (CPU) and a memory, and controls an overall operation of the battery pack. The controller 206 detects and controls a use state of the electric power source 201 on an as-needed basis.

If a voltage of the electric power source 201 (the secondary battery) reaches an overcharge detection voltage or an overdischarge detection voltage, the controller 206 turns off the switch 207. This prevents a charging current from flowing into a current path of the electric power source 201. The overcharge detection voltage is not particularly limited, and is specifically 4.2 V 0.05 V. The overdischarge detection voltage is not particularly limited, and is specifically 2.4 V 0.1 V.

The switch 207 includes, for example, a charge control switch, a discharge control switch, a charging diode, and a discharging diode. The switch 207 performs switching between coupling and decoupling between the electric power source 201 and external equipment in accordance with an instruction from the controller 206. The switch 207 includes, for example, a metal-oxide-semiconductor field-effect transistor (MOSFET). The charging and discharging currents are detected based on an ON-resistance of the switch 207.

The temperature detector 209 includes a temperature detection device such as a thermistor. The temperature detector 209 measures a temperature of the electric power source 201 using the temperature detection terminal 205, and outputs a result of the temperature measurement to the controller 206. The result of the temperature measurement to be obtained by the temperature detector 209 is used, for example, in a case where the controller 206 performs charge/discharge control upon abnormal heat generation or in a case where the controller 206 performs a correction process upon calculating a remaining capacity.

### EXAMPLES

A description is given of Examples of the present technology according to an embodiment.

### Examples 1 to 5 and Comparative Examples 1 to 4

Secondary batteries were fabricated, following which the secondary batteries were each evaluated for a battery characteristic as described below.

### [Fabrication of Secondary Battery]

The secondary batteries of the laminated-film type (the lithium-ion secondary batteries) illustrated in FIGS. 18 and 19 were fabricated in accordance with the following procedure.

### (Fabrication of Positive Electrode)

The positive electrode 41 having the configuration described in Table 1 was fabricated. Note that details of the configuration of the positive electrode 41 described in Table 1 were as follows. The column of “Corresponding drawing” indicates the number of the drawing corresponding to the configuration of the positive electrode 41 (the positive electrode body). The column of “Exposure” indicates whether a portion of the positive electrode current collector 41A was exposed without being covered with the positive electrode active material layer 41B.

In a case of fabricating the positive electrode 41 corresponding to the electrode 10 illustrated in FIG. 1 (Examples 1 and 3), first, 91 parts by mass of the positive electrode active material (LiCoO₂ as the lithium-containing compound (the oxide)), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into a solvent (N-methyl-2-pyrrolidone as the organic solvent), following which the organic solvent was stirred to thereby prepare a positive electrode mixture slurry in a paste form. Thereafter, the positive electrode mixture slurry was continuously applied on the two opposed surfaces of the positive electrode current collector 41A (a band-shaped aluminum foil having a thickness of 15 μm) by means of a coating apparatus, following which the applied positive electrode mixture slurry was dried to thereby form the positive electrode active material layers 41B continuously in such a manner that no portion of the positive electrode current collector 41A was exposed. Thereafter, the positive electrode active material layers 41B were compression-molded by means of a roll pressing machine. In this manner, the positive electrode body corresponding to the electrode body 1, that is, the band-shaped positive electrode body including the positive electrode current collector 41A and the positive electrode active material layers 41B was formed.

Thereafter, the protective member 190 having the configuration described in Table 1 was adhered to each of the two opposed surfaces (the upper surface and the lower surface) of the positive electrode body, following which the positive electrode body was cut together with the protective members 190 by means of a cutting apparatus including a scissors-type cutting blade (cemented carbide). Note that details of the configuration of the protective member 190 described in Table 1 were as follows. The columns of “Unadhered part” and “Adhered part” indicate presence or absence of the unadhered part 2X and the adhered part 2Y, respectively. The column of “Adhesion location (Adhesion surface)” indicates a location (a component of the positive electrode 41) to which the protective member 190 was adhered and the surface on which the protective member 190 was adhered (one or both of the two opposed surfaces). The column of “Cutting location” indicates a location (a component) at which the protective member 190 was cut.

Here, the protective members 190 each including the unadhered part 2X and the paired adhered parts 2Y and having the length L1 of 20 mm were adhered to the positive electrode body (the respective positive electrode active material layers 41), following which the positive electrode body was cut together with the protective members 190 at the unadhered parts 2X. As each of the protective members 190, a protective tape was used that included the base layer 2A (a polyimide film as the non-fluorine-containing polymer compound) having a thickness of 10 μm and the adhesive layer 2B (an acrylic-based adhesive) having a thickness of 10 μm. The configuration of the protective member 190 described here is similarly applicable in the following description. In such a manner, the positive electrode 41 was fabricated.

The procedure of fabricating the positive electrode 41 corresponding to the electrode 20 illustrated in FIG. 14 (Example 2) was similar to the above-described procedure of fabricating the positive electrode 41 (Example 1) except for the following.

Specifically, the positive electrode mixture slurry was intermittently applied on each of the two opposed surfaces of the positive electrode current collector 41A to thereby intermittently form the positive electrode active material layers 41B to allow a portion of the positive electrode current collector 41A to be exposed. In addition, the protective members 190 each including the unadhered part 2X and the paired adhered parts 2Y and having the length L6 of 20 mm and the length L7 of 10 mm were adhered to the positive electrode body (the positive electrode current collector 41A and the positive electrode active material layers 41), following which the positive electrode body was cut together with the protective members 190 at the unadhered parts 2X.

The procedure of fabricating the positive electrode 41 corresponding to the electrode 10 illustrated in FIG. 24 (Examples 4 and 5) was similar to the above-described procedure of fabricating the positive electrode 41 (Examples 1 and 3) except that the protective members 190 were adhered only on one (the upper surface) of the two opposed surfaces of the positive electrode body.

Note that for comparison, the positive electrode 41 having each of the configurations described in Table 2 was also fabricated.

The procedure of fabricating the positive electrode 41 corresponding to the electrode 100 illustrated in FIG. 6 (Comparative example 1) was similar to the above-described procedure of fabricating the positive electrode 41 (Examples 1 and 3) except that no protective member 190 was used and only the positive electrode body was cut.

The procedure of fabricating the positive electrode 41 corresponding to the electrode 200 illustrated in FIG. 8 (Comparative example 2) was similar to the above-described procedure of fabricating the positive electrode 41 (Examples 1 and 3) except for the following.

Specifically, the positive electrode mixture slurry was continuously applied on the two opposed surfaces of the positive electrode current collector 41A to thereby form the positive electrode body in such a manner that no portion of the positive electrode current collector 41A was exposed. Thereafter, the positive electrode body was cut by means of a cutting apparatus. Further, the protective members 192 (having the length L2 of 120 mm and the length L3 of 20 mm) were adhered to each of the two pieces of the positive electrode body adjacent to each other, and the protective members 192 were adhered to each other between the two pieces of the positive electrode body. Thereafter, the protective members 192 were cut by means of a cutting apparatus. Here, the protective members 192 each including only the adhered part 2Y were adhered to the positive electrode body (the positive electrode active material layers 41), following which the protective members 192 were cut at the adhered parts 2Y.

The procedure of fabricating the positive electrode 41 corresponding to the electrode 300 illustrated in FIG. 10 (Comparative example 3) was similar to the above-described procedure of fabricating the positive electrode 41 (Examples 1 and 3) except for the following.

Specifically, the positive electrode mixture slurry was intermittently applied on each of the two opposed surfaces of the positive electrode current collector 41A to thereby form the positive electrode body to allow a portion of the positive electrode current collector 41A to be exposed. In addition, the protective members 192 each including only the adhered part 2Y and having the length L4 of 20 mm and the length L5 of 70 mm were adhered to the positive electrode body (the positive electrode current collector 41A and the positive electrode active material layers 41B) to allow a portion of the positive electrode current collector 41A was exposed, following which the positive electrode body was cut at the positive electrode current collector 41A together with the protective members 192.

The procedure of fabricating the positive electrode 41 corresponding to the electrode 400 illustrated in FIG. 12 (Comparative example 4) was similar to the above-described procedure of fabricating the positive electrode 41 (Examples 1 and 3) except for the following.

Specifically, the protective members 192 each including only the adhered part 2Y and having the length L6 of 20 mm were adhered to the positive electrode body (the positive electrode active material layers 41B), following which the positive electrode body was cut together with the protective members 192 at the adhered parts 2Y.

### (Fabrication of Negative Electrode)

First, 93 parts by mass of the negative electrode active material (artificial graphite as the carbon material and silicon oxide (SiO) as the metal-based material) and 7 parts by mass of the negative electrode binder (polyvinylidene difluoride) were mixed with each other to thereby obtain a negative electrode mixture. A mixture ratio (a weight ratio) between artificial graphite and silicon oxide in the negative electrode active material was set to 93:7. Thereafter, the negative electrode mixture was put into a solvent (N-methyl-2-pyrrolidone as the organic solvent), following which the organic solvent was stirred to thereby prepare a negative electrode mixture slurry in a paste form. Thereafter, the negative electrode mixture slurry was applied on the two opposed surfaces of the negative electrode current collector 42A (a band-shaped copper foil having a thickness of 15 μm) by means of a coating apparatus, following which the applied negative electrode mixture slurry was dried to thereby form the negative electrode active material layers 42B. Lastly, the negative electrode active material layers 42B were compression-molded by means of a roll pressing machine. In this manner, the negative electrode 42 was fabricated.

### (Preparation of Electrolytic Solution)

The electrolyte salt (LiPF₆ as the lithium salt) was added to the solvent (ethylene carbonate and diethyl carbonate as the carbonic-acid-ester-based compound), following which the solvent was stirred. In this case, a mixture ratio (a weight ratio) between ethylene carbonate and diethyl carbonate in the solvent was set to 30:70, and a content of the electrolyte salt was set to 1 mol/kg with respect to the solvent. In such a manner, the electrolytic solution was prepared.

### (Assembly of Secondary Battery)

First, the positive electrode lead 51 including aluminum was welded to the positive electrode current collector 41A of the positive electrode 41, and the negative electrode lead 52 including copper was welded to the negative electrode current collector 42A of the negative electrode 42.

Thereafter, the positive electrode 41 and the negative electrode 42 were stacked on each other with the separator 43 (a fine porous biaxially oriented polyethylene film having a thickness of 15 μm) interposed therebetween, following which the stack of the positive electrode 41, the negative electrode 42, and the separator 43 was wound to thereby fabricate a wound body.

In this case, the separator 43 having the configuration described in Table 1 was used. Note that details of the configuration of the separator 43 described in Table 1 were as follows. The column of “Corresponding drawing” indicates the number of the drawing corresponding to the configuration of the separator 43. The column of “Folding back” indicates whether the leading end part 43P of the separator 43 was folded back to overlap with the protective member 2.

In a case where the leading end part 43P was not folded back (Examples 1, 2, and 4), the positive electrode 41 and the negative electrode 42 were stacked on each other with the separator 43 interposed therebetween without the leading end part 43P being folded back, following which the stack of the positive electrode 41, the negative electrode 42, and the separator 43 was wound. The leading end part 43P was thus not sandwiched by the positive electrode 41 and the negative electrode 42, therefore being a free end.

In a case where the leading end part 43P was folded back (Examples 3 and 5), the leading end part 43P was folded back, following which the positive electrode 41 and the negative electrode 42 were stacked on each other with the separator 43 interposed therebetween, and the stack of the positive electrode 41, the negative electrode 42, and the separator 43 was wound. The leading end part 43P was thus caused to overlap with the protective member 2 on a side (the lower surface) where the protective member 2 was unadhered to the positive electrode body. In addition, the leading end part 43P was thus sandwiched by the positive electrode 41 and the negative electrode 42, therefore being a fixed end.

Thereafter, the wound body was pressed by means of a pressing machine, and was thereby shaped into an elongated shape.

Thereafter, the outer package film 30 was folded in such a manner as to sandwich the wound body contained inside the depression part 30U. As the outer package film 30, an aluminum laminated film was used in which the fusion-bonding layer (a polypropylene film having a thickness of 30 μm), the metal layer (an aluminum foil having a thickness of 40 μm), and the surface protective layer (a nylon film having a thickness of 25 μm) were stacked in this order from an inner side. Thereafter, the outer edge parts of two sides of the outer package film 30 (the fusion-bonding layer) were thermal-fusion-bonded to each other to thereby allow the wound body to be contained inside the outer package film 30 having the pouch shape.

Lastly, the electrolytic solution was injected into the outer package film 30 having the pouch shape, following which the outer edge parts of the remaining one side of the outer package film 30 (the fusion-bonding layer) were thermal-fusion-bonded to each other in a reduced-pressure environment. In this case, the sealing film 61 (a polypropylene film having a thickness of 5 μm) was interposed between the outer package film 30 and the positive electrode lead 51, and the sealing film 62 (a polypropylene film having a thickness of 5 μm) was interposed between the outer package film 30 and the negative electrode lead 52. In this manner, the wound body was impregnated with the electrolytic solution. As a result, the battery device 40 that was the wound electrode body was fabricated. Accordingly, the battery device 40 was sealed in the outer package film 30. As a result, the secondary battery was assembled.

### (Stabilization of Secondary Battery)

The assembled secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of 4.2 V until a current reached 0.05 C. Upon discharging, the secondary battery was discharged with a constant current of 0.1 C until the voltage reached 3.0 V. Note that 0.1 C was a value of a current that caused a battery capacity (a theoretical capacity) to be completely discharged in 10 hours, and 0.05 C was a value of a current that caused the battery capacity to be completely discharged in 20 hours. In this manner, the secondary battery of the laminated-film type was completed.

### [Evaluation of Battery Characteristic]

Evaluation of the secondary batteries for their battery characteristics (a capacity characteristic, safety, and manufacturing stability) revealed the results presented in Tables 1 and 2.

### (Capacity Characteristic)

In a case of evaluating the capacity characteristic, the secondary battery was charged and discharged in an ambient temperature environment to thereby measure a discharge capacity. Upon charging, the secondary battery was charged with a constant current of 0.2 C until a voltage reached 4.2 V, and was thereafter charged with a constant voltage of that value, 4.2 V, until a total charging time reached 6 hours. Upon discharging, the secondary battery was discharged with a constant current of 0.2 C until the voltage reached 2.0 V. Note that 0.2 C was a value of a current that caused a battery capacity to be completely discharged in 5 hours.

Thereafter, a capacity decrease rate (%), which was an index for evaluating the capacity characteristic, was calculated based on the following calculation expression: [(reference discharge capacity−discharge capacity)/reference discharge capacity]×100. In the above-described calculation expression, the “reference discharge capacity” refers to the discharge capacity of the secondary battery in Comparative example 1, and the “discharge capacity” refers to a discharge capacity in each of Examples 1 to 5 and Comparative examples 2 to 4.

### (Safety)

In a case of evaluating the safety, a cycling test was conducted with use of the secondary battery, following which a drop test was conducted with use of the secondary battery to calculate a short-circuit occurrence rate (%) that was an index for evaluating the safety.

In the cycling test, the secondary battery was repeatedly charged and discharged in a low temperature environment (at a temperature of 0° C.). Upon charging, the secondary battery was charged with a constant current of 1 C until a voltage reached 4.25 V, and was thereafter charged with a constant voltage of that value, 4.25 V, until the current reached 100 mA. Upon discharging, the secondary battery was discharged with a constant current of 2 C until the voltage reached 2.0 V. Note that 1 C was a value of a current that caused a battery capacity to be completely discharged in 1 hour, and 2 C was a value of a current that caused the battery capacity to be completely discharged in 0.5 hour.

In a case of repeatedly charging and discharging the secondary battery, the secondary battery was charged and discharged while a temperature of the secondary battery was measured. Thus, after the temperature of the secondary battery reached 0° C. after the discharging, the process of charging and discharging the secondary battery was repeated again.

In this case, in repeating the process of charging and discharging the secondary battery, the capacity retention rate (%) was calculated after completion of the charging and discharging. Thus, the current at the time of discharging was changed to 1 C when the capacity retention rate reached 30% or lower, following which the current at the time of discharging was changed to 0.5 C when the capacity retention rate reached 30% or lower again. In such a manner, the secondary battery was repeatedly charged and discharged until the capacity retention rate eventually reached 30% or lower.

Note that the capacity retention rate in a case where n-cycles of the charging and discharging process of the secondary battery were performed was calculated based on the following calculation expression: capacity retention rate (%)=(nth-cycle discharge capacity/first-cycle discharge capacity)×100.

In the drop test, conducted was a drop test (a limit test) of the secondary battery defined in “Guideline for Safety Evaluation on Lithium Secondary Batteries” (SBA G1101), more specifically, in SBA G(23) JP2018-10764 A 2018.1.18 1101, except that the secondary battery after being subjected to the cycling test was dropped 20 times instead of 10 times. In this case, the secondary battery was dropped onto a concrete floor from a height of 1.9 m or 10 m, and the number of the secondary batteries subjected to the test was set to 10. Thus, whether a short circuit occurred in the secondary batteries after the drop test was checked.

The short-circuit occurrence rate (%) was thereby calculated based on the following calculation expression: short-circuit occurrence rate (%)=(number of secondary batteries in which a short circuit occurred/number of secondary batteries subjected to the test (=10))×100.

Details of the “short-circuit occurrence rate” presented in Tables 1 and 2 were as follows. “Short-circuit occurrence rate 1” indicates a short-circuit occurrence rate in a case where the secondary battery was dropped from the height of 1.9 m. “Short-circuit occurrence rate 2” indicates a short-circuit occurrence rate in a case where the secondary battery was dropped from the height of 10 m.

### (Manufacturing Stability)

In a case of evaluating the manufacturing stability, whether the positive electrode 41 was wound together with the negative electrode 42 and the separator 43 without any inconvenience was visually checked in the process of fabricating the battery device 40. A defective winding rate (%) that was an index for evaluating the manufacturing stability was thereby calculated.

Here, in a case where no adhesive material of the protective member 2 or 3 (the adhesive layer 2B) stuck to any of the components including, without limitation, the positive electrode 41 and therefore the components including, without limitation, the positive electrode 41 were normally wound without any inconvenience such as winding displacement, it was determined that no defective winding occurred. In contrast, in a case where the adhesive material stuck to the components including, without limitation, the positive electrode 41 and therefore the components including, without limitation, the positive electrode 41 were unable to be normally wound due to occurrence of inconvenience such as winding displacement, it was determined that the defective winding occurred. In this case, the number of the fabricated battery devices 40 was set to 20.

The defective winding rate was thereby calculated based on the following calculation expression: defective winding rate (%)=(number of battery devices 40 in which defective winding occurred/number of fabricated battery devices 40 (=20))×100.

In the case of evaluating the manufacturing stability, whether the cutting process was performed without any inconvenience was checked while the state of the cutting blade and the state of the positive electrode body were each visually checked every time the cutting process was performed 10 times with use of the cutting apparatus in the process of fabricating the positive electrode 41. The number of times of cutting (times) that was another index for evaluating the manufacturing stability was thereby identified.

Here, in a case where no or only a small amount of the adhesive material stuck to the cutting blade and therefore the cutting process was normally performed, it was determined that no cutting failure occurred. In contrast, in a case where an excessive amount of the adhesive material stuck to the cutting blade and therefore the cutting process was unable to be performed normally, it was determined that the cutting failure occurred.

In such a manner, a maximum value (the number of times of cutting) of the number of times the cutting process was normally performed without replacing the cutting blade was identified.

TABLE 1

| | Positive | | Protective member | | | | | |
|---|---|---|---|---|---|---|---|---|
| | electrode body | | | | Adhesion | | Separator | |
| | Corre- | | | | location | | Corre- | |
| | sponding | | Unadhered | Adhered | (Adhesion | Cutting | sponding | Folding |
| Example | FIG. | Exposure | part | part | surface) | location | FIG. | back |
| 1 | FIG. 1 | Absent | Present | Present | Positive | Unadhered | — | Absent |
| | | | | | electrode | part | | |
| | | | | | active | | | |
| | | | | | material | | | |
| | | | | | layer | | | |
| | | | | | (Both | | | |
| | | | | | surfaces) | | | |
| 2 | FIG. 14 | Present | Present | Present | Positive | Unadhered | — | Absent |
| | | | | | electrode | part | | |
| | | | | | current | | | |
| | | | | | colloector + | | | |
| | | | | | Positive | | | |
| | | | | | electrode | | | |
| | | | | | active | | | |
| | | | | | material | | | |
| | | | | | layer | | | |
| | | | | | (Both | | | |
| | | | | | surfaces) | | | |
| 3 | FIG. 1 | Absent | Present | Present | Positive | Unadhered | FIG. 22 | Present |
| | | | | | electrode | part | | |
| | | | | | active | | | |
| | | | | | material | | | |
| | | | | | layer | | | |
| | | | | | (Both | | | |
| | | | | | surfaces) | | | |
| 4 | FIG. 24 | Absent | Present | Present | Positive | Unadhered | — | Absent |
| | | | | | electrode | part | | |
| | | | | | active | | | |
| | | | | | material | | | |
| | | | | | layer | | | |
| | | | | | (One | | | |
| | | | | | surface) | | | |
| 5 | FIG. 24 | Absent | Present | Present | Positive | Unadhered | FIG. 25 | Present |
| | | | | | electrode | part | | |
| | | | | | active | | | |
| | | | | | material | | | |
| | | | | | layer | | | |
| | | | | | (One | | | |
| | | | | | surface) | | | |

| | Short- | Short- | | | |
|---|---|---|---|---|---|
| | circuit | circuit | Defective | Number of | Capacity |
| | occurrence | occurrence | winding | times of | decrease |
| | rate 1 | rate 2 | rate | cutting | rate |
| Example | (%) | (%) | (%) | (times) | (%) |
| 1 | 0 | 2 | 0 | 11000 | 1.7 |
| 2 | 0 | 0 | 0 | 12000 | 2.0 |
| 3 | 0 | 0 | 0 | 11000 | 1.7 |
| 4 | 0 | 10 | 0 | 11500 | 0.85 |
| 5 | 0 | 0 | 0 | 11500 | 0.85 |

TABLE 2

| | Positive | | Protective member | | | | | |
|---|---|---|---|---|---|---|---|---|
| | electrode body | | | | Adhesion | | Separator | |
| Compar- | Corre- | | | | location | | Corre- | |
| ative | sponding | | Unadhered | Adhered | (Adhesion | Cutting | sponding | Folding |
| example | figure | Exposure | part | part | surface) | location | figure | back |
| 1 | FIG. 6 | Absent | — | — | — | — | — | Absent |
| 2 | FIG. 8 | Absent | Absent | Present | Positive | Adhered | — | Absent |
| | | | | | electrode | part | | |
| | | | | | active | | | |
| | | | | | material | | | |
| | | | | | layer | | | |
| | | | | | (Both | | | |
| | | | | | surfaces) | | | |
| 3 | FIG. 10 | Present | Absent | Present | Positive | Current | — | Absent |
| | | | | | electrode | collector | | |
| | | | | | current | | | |
| | | | | | colloector + | | | |
| | | | | | Positive | | | |
| | | | | | electrode | | | |
| | | | | | active | | | |
| | | | | | material | | | |
| | | | | | layer | | | |
| | | | | | (Both | | | |
| | | | | | surfaces) | | | |
| 4 | FIG. 12 | Absent | Absent | Present | Positive | Adhered | — | Absent |
| | | | | | electrode | part | | |
| | | | | | active | | | |
| | | | | | material | | | |
| | | | | | layer | | | |
| | | | | | (Both | | | |
| | | | | | surfaces) | | | |

| | Short- | Short- | | | |
|---|---|---|---|---|---|
| | circuit | circuit | Defective | Number of | Capacity |
| Compar- | occurrence | occurrence | winding | times of | decrease |
| ative | rate 1 | rate 2 | rate | cutting | rate |
| example | (%) | (%) | (%) | (times) | (%) |
| 1 | 20 | 100 | 0 | 11100 | 0 |
| 2 | 0 | 0 | 35 | 30 | 10.0 |
| 3 | 0 | 0 | 0 | 12500 | 4.0 |
| 4 | 0 | 0 | 70 | 20 | 2.0 |

As indicated in Tables 1 and 2, the short-circuit occurrence rates 1 and 2, the defective winding rate, the number of times of cutting, and the capacity decrease rate each varied depending on the configuration of the positive electrode 41.

Specifically, in a case (Comparative example 1) where no protective member 2 was used, the defective winding rate was 0% and the number of times of cutting reached 10,000 times or more, but the short-circuit occurrence rates 1 and 2 each increased.

In a case (Comparative example 2) where the respective protective members 192 (each including the adhered part 2Y) were adhered to the two opposed surfaces of the positive electrode body (the positive electrode active material layers 41B) and the protective members 192 were adhered to each other and were thereafter cut at the adhered parts 2Y, the short-circuit occurrence rates 1 and 2 were each 0%, but the defective winding rate and the capacity decrease rate each increased and the number of times of cutting greatly decreased.

In a case (Comparative example 3) where the respective protective members 192 (each including the adhered part 2Y) were adhered to the two opposed surfaces of the positive electrode body (the positive electrode current collector 41A and the positive electrode active material layers 41B) and thereafter the positive electrode current collector 41A was cut, the short-circuit occurrence rates 1 and 2 were each 0%, and the number of times of cutting reached 10,000 times or more, but the capacity decrease rate increased.

In a case (Comparative example 4) where the respective protective members 192 (each including the adhered part 2Y) were adhered to the two opposed surfaces of the positive electrode body (the positive electrode active material layers 41B) and thereafter the protective members 192 were cut at the adhered parts 2Y, the short-circuit occurrence rates 1 and 2 were each 0%, and the capacity decrease rate was low, but the defective winding rate increased and the number of times of cutting greatly decreased.

In contrast, in a case (Example 1) where the respective protective members 190 (each including the unadhered part 2X and the adhered parts 2Y) were adhered to the two opposed surfaces of the positive electrode body (the positive electrode active material layers 41B) and thereafter the protective members 190 were cut at the unadhered parts 2X, the short-circuit occurrence rate 1 and the defective winding rate were each 0%, and the capacity decrease rate was low, and in addition, the number of times of cutting reached 10,000 times or more.

In a case (Example 2) where the respective protective members 190 (each including the unadhered part 2X and the adhered parts 2Y) were adhered to the two opposed surfaces of the positive electrode body (the positive electrode current collector 41A and the positive electrode active material layers 41B) and thereafter the protective members 190 were cut at the unadhered parts 2X, the short-circuit occurrence rate 1 and the defective winding rate were each 0%, and the capacity decrease rate was low, and in addition, the number of times of cutting reached 10,000 times or more.

In a case (Example 4) where the protective member 190 (including the unadhered part 2X and the adhered parts 2Y) was adhered to one of the two opposed surfaces of the positive electrode body (the positive electrode active material layer 41B) and thereafter the protective member 190 was cut at the unadhered part 2X, the short-circuit occurrence rate 1 and the defective winding rate were each 0%, and the capacity decrease rate was low, and in addition, the number of times of cutting reached 10,000 times or more.

Note that in a case (Examples 1 and 4) where the leading end part 43P was not folded back, the short-circuit occurrence rate 2 slightly increased, but was sufficiently suppressed to fall within an allowable range.

In particular, in a case where the protective members 2 were used (Examples 1 to 5), the following tendencies were obtained. Firstly, in a case (Example 1) where the positive electrode 41 corresponding to the electrode 10 illustrated in FIG. 1 was used, the capacity decrease rate decreased as compared with a case (Example 2) where the positive electrode 41 corresponding to the electrode 20 illustrated in FIG. 14 was used. Secondly, in a case (Example 4) where the protective member 190 was adhered to only one of the two opposed surfaces of the positive electrode body and the protective members 2 were therefore provided on only one of the two opposed surfaces of the positive electrode body, the capacity decrease rate decreased as compared with a case (Example 1) where the respective protective members 190 were adhered to the two opposed surfaces of the positive electrode body and the protective members 2 were therefore provided on both the two opposed surfaces of the positive electrode body. Thirdly, in a case (Examples 3 and 5) where the leading end part 43P was folded back, the short-circuit occurrence rate 2 decreased as compared with a case (Examples 1 and 4) where the leading end part 43P was not folded back. More specifically, in the case (Examples 3 and 5) where the leading end part 43P was folded back, the short-circuit occurrence rate 2 decreased down to 0%.

Based upon the results presented in Table 1, the capacity decrease rate was sufficiently suppressed, the lowest short-circuit occurrence rate 1 and the lowest defective winding rate were achieved, and the sufficient number of times of cutting was achieved in a case where: the positive electrode 41 included the positive electrode body (the positive electrode current collector 41A and the positive electrode active material layers 41B) and the protective members 2 (each including the unadhered part 2X and the adhered parts 2Y); and the unadhered part 2X was unadhered to the positive electrode body on the side closer to the exposed face 1AR whereas the adhered parts 2Y were each adhered to the positive electrode body on the side farther from the exposed face 1AR. In such a case, it was therefore possible to achieve a superior capacity characteristic, superior safety, and superior manufacturing stability.

Although the present technology has been described above with reference to one or more embodiments including Examples, the configuration of the present technology is not limited thereto, and is therefore modifiable in a variety of suitable ways.

The description has been given of the case where the secondary battery has a battery structure of the laminated-film type, the prismatic type, or the cylindrical type. However, the battery structure of the secondary battery is not particularly limited. Specifically, the battery structure may be, for example, a coin type or a button type.

Further, the description has been given of the case where the battery device has a device structure of the wound type or the stacked type. However, the device structure of the battery device is not particularly limited in kind. Specifically, the device structure may be a zigzag folded type in which the electrodes (the positive electrode and the negative electrode) are folded in a zigzag manner, or any other type.

Further, although the description has been given of the case where the electrode reactant is lithium, the electrode reactant is not particularly limited in kind. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be appreciated that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An electrode comprising:
an electrode body; and
a protective member that covers a surface of the electrode body, wherein
the electrode body includes
a current collector having a first end face, and
an active material layer provided on at least a portion of a surface of the current collector, and
the protective member includes
an unadhered part that is disposed on a side closer to the first end face and is unadhered to the electrode body, and
an adhered part that is disposed on a side farther from the first end face, is coupled to the unadhered part, and is adhered to the electrode body.

2. The electrode according to claim 1, wherein the unadhered part is in contact with the electrode body.

3. The electrode according to claim 1, wherein
the active material layer is provided on all of the surface of the current collector, and
the protective member is disposed on the active material layer.

4. The electrode according to claim 3, wherein
the active material layer has a second end face on the side closer to the first end face, and
a portion of the unadhered part covers a portion of the second end face.

5. The electrode according to claim 1, wherein
the active material layer has a second end face on the side closer to the first end face and is provided on the portion of the surface of the current collector,
the second end face is recessed relative to the first end face toward an inner side of the active material layer, and
the protective member is disposed on both the current collector and the active material layer.

6. The electrode according to claim 1, wherein
the protective member includes
a base layer, and
an adhesive layer provided on the base layer in a range corresponding to the adhered part.

7. The electrode according to claim 6, wherein
the base layer includes a non-fluorine-containing polymer compound, a fluorine-containing polymer compound, or both,
the non-fluorine-containing polymer compound includes at least one of polyethylene, polypropylene, polyimide, polyphenylene sulfide, polyvinyl chloride, or polyester, and
the fluorine-containing polymer compound includes at least one of polyvinylidene difluoride, polytetrafluoroethylene, a perfluoroalkoxy alkane (a copolymer of tetrafluoroethylene and perfluoroalkoxy ethylene), or a perfluoroethylene propene copolymer (a copolymer of tetrafluoroethylene and hexafluoropropylene).

8. The electrode according to claim 6, wherein the protective member includes a colorant within the range corresponding to the adhered part.

9. A method of manufacturing an electrode, the method comprising:
preparing an electrode body and a protective member, the electrode body including a current collector and an active material layer provided on the current collector, the protective member including an unadhered part and paired adhered parts, the paired adhered parts being opposed to each other with the unadhered part interposed between the paired adhered parts;
adhering the protective member to a surface of the electrode body via the paired adhered parts; and
cutting the electrode body together with the protective member at the unadhered part.

10. The method of manufacturing an electrode according to claim 9, wherein at least one cutting method is used to cut each of the electrode body and the protective member, the at least one cutting method comprising at least one of a scissors method, a nip-type fixed blade cutting method, a rotary cutter method, a gang blade method, a shear blade method, or a score blade method.

11. A battery comprising:
a first electrode; and
an electrolytic solution, wherein
the first electrode includes
an electrode body, and
a protective member that covers a surface of the electrode body,
the electrode body includes
a current collector having a first end face, and
an active material layer provided on at least a portion of a surface of the current collector, and
the protective member includes
an unadhered part that is disposed on a side closer to the first end face and is unadhered to the electrode body, and
an adhered part that is disposed on a side farther from the first end face, is coupled to the unadhered part, and is adhered to the electrode body.

12. The battery according to claim 11, wherein the first electrode is wound.

13. The battery according to claim 12, wherein the protective member covers the surface of the electrode body on an inner side of winding or on an outer side of the winding.

14. The battery according to claim 13, further comprising
a first separator opposed to the first electrode and wound, wherein
the protective member covers the surface of the electrode body on an opposite side to a side where the first separator is opposed to the first electrode,
the first separator includes a first leading end part protruding relative to the first electrode toward a center of the winding, and
the first leading end part is folded back to overlap with the protective member.

15. The battery according to claim 14, further comprising:
a second electrode having a polarity opposite to a polarity of the first electrode, the second electrode being opposed to the first electrode with the first separator interposed between the second electrode and the first electrode and being wound; and
a second separator that is opposed to the first separator with the second electrode interposed between the second separator and the first separator and is wound, wherein
the second separator includes a second leading end part protruding relative to the second electrode toward the center of the winding, and
the second leading end part is folded back to overlap with the protective member.

16. The battery according to claim 12, wherein the protective member covers the surface of the electrode body on each of an inner side of winding and an outer side of the winding.

17. The battery according to claim 16, further comprising
a first separator opposed to the first electrode and wound, wherein
the first separator includes a first leading end part protruding relative to the first electrode toward a center of the winding, and
the first leading end part is folded back to overlap with the protective member that covers the surface of the electrode body on the inner side of the winding or the outer side of the winding.

18. The battery according to claim 17, further comprising:
a second electrode having a polarity opposite to a polarity of the first electrode, the second electrode being opposed to the first electrode with the first separator interposed between the second electrode and the first electrode and being wound; and
a second separator that is opposed to the first separator with the second electrode interposed between the second separator and the first separator and is wound, wherein
the second separator includes a second leading end part protruding relative to the second electrode toward the center of the winding, and
the second leading end part is folded back to overlap with the protective member with which the first leading end part overlaps.
